(19) United States
(12) Patent Application Publication
(10) Pub. No.: US 2025/0133564 A1
(43) Pub. Date: Apr. 24, 2025

(54) USER EQUIPMENT (UE) GROUPING & RELAYING TECHNIQUES

(71) Applicant: QUALCOMM Incorporated, San Diego, CA (US)

(72) Inventors: Runxin Wang, San Diego, CA (US); Yu Zhang, San Diego, CA (US); Muhammad Sayed Khairy Abdelghaffar, San Jose, CA (US)

(21) Appl. No.: 18/692,578

(22) PCT Filed: Nov. 20, 2021
(86) PCT No.: PCT/CN2021/131959

§ 371 Date: Mar. 15, 2024

(51) Int. Cl. H04W 72/1273; H04B 7/06; H04W 24/08; H04W 24/10; H04W 88/04

(52) U.S. Cl. CPC H04W 72/1273; H04B 7/0626; H04W 24/08; H04W 24/10; H04W 88/04

(57) ABSTRACT

Techniques related to communication device groups and relaying wireless signaling are disclosed. Some aspects of the disclosure relate to devices and methods for receiving an indication configured to indicate that a first device (e.g., a destination user equipment (UE)) is to monitor: at least one first radio link, and at least one second radio link, for at least one data flow. The first device may receive: a first portion of the at least one data flow including DL data over the at least one first radio link, and/or a second portion of the at least one data flow including relay data over the at least one second radio link. The device may transmit an indication corresponding to at least one of: the DL data or the relay data. Other aspects, embodiments, and features are also claimed and described.

### TECHNICAL FIELD

The technology discussed below relates generally to wireless communication systems, and more particularly, to wireless communication systems capable of utilizing a radio links for transmitting data between various wireless communication devices (e.g., scheduling and/or scheduled entities). Certain aspects may relate to techniques for enabling and providing multiple device grouping and relay techniques associated with multiple devices.

### INTRODUCTION

Radio access networks may include many different wireless communication devices. These may include user equipment (UE) devices and network-type devices (e.g., base stations or network elements). A radio access network generally facilitates communication by and between UEs. Accordingly, numerous UEs may leverage such radio links to communicate data with one or more other wireless communication devices. In addition, UEs and network elements may provide signaling information, such as channel state coefficients, between one another to further provide robust wireless communication between devices.

UEs utilize various network elements of a radio access network to handle exchanges or in some instances, coordinate an improvement of the radio links. In some examples, a network element may transmit a flow of data to a UE over a radio link. The UE may monitor certain portions of the radio link as necessary to receive data and/or signaling information. In such examples, the UE and the network element may adapt to changes on the network to maintain robust wireless connections.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

Some aspects of the disclosure relate to wireless communication systems enabling and providing enhanced communication techniques. In some examples, some wireless communication techniques are capable of utilizing a configurable radio link arrangement for communications (e.g., receive and/or transmit data flows). Additionally or alternatively, some wireless communication techniques can include a dynamic and/or configurable arrangement of radio links for communications (e.g., to receive and/or transmit a data flow). In an example, an upstream node transmits a relay portion of a data flow to a downstream device (e.g., a destination user equipment (UE)) via at least one relay device. The upstream node transmits a second portion of the data flow to the downstream device via another radio link between the upstream node and the downstream device.

Some aspects may include enabling and providing communication devices and methods configured to receive and transmit data flows. According to sample aspects, some methods can operate at a destination user equipment (UE). A data flow can be received by a UE from at least one relay device. The relay device may in some aspects be in a set of UEs. Additionally or alternatively, the data flow can be transmitted from a network node (e.g., one that is upstream relative to the set of UEs). Still yet, additional and/or alternative aspects may include enabling and providing communication devices and methods configured to receive a variety of data flow signaling from various other wireless communication devices (e.g., from an upstream node, a portion of a data flow including relay data, and to transmit the relay data to a destination UE).

In one aspect, the present disclosure provides a method of wireless communication operable at a first device (e.g., a destination user equipment (UE), a road side unit (RSU), etc.). In some scenarios, the method includes receiving, from at least one scheduling entity, an indication configured to indicate that the first device is to monitor at least one first radio link and at least one second radio link for at least one data flow from the at least one scheduling entity. In some scenarios, the method further includes receiving at least one of: a first portion of at least one data flow via at least one first radio link, the first portion including downlink (DL) data for the first device, or a second portion of the at least one data flow via at least one second radio link, the second portion including relay data for the first device. And in additional and/or alternative scenarios, the method includes transmitting an indication corresponding to at least one of: the DL data, or the relay data.

In another aspect, a wireless communication device is provided. The device includes a memory, and processing circuitry coupled to the memory. In some scenarios, the device, via at least the processing circuitry, is configured to receive, via the transceiver, an indication configured to indicate that the wireless communication device is to monitor at least one first radio link and at least one second radio link for at least one data flow from the at least one scheduling entity. In some scenarios, the processing circuitry may receive at least one of: a first portion of at least one data flow over at least one first radio link, the first portion including downlink (DL) data for the wireless communication device, or a second portion of the at least one data flow over at least one second radio link, the second portion including relay data for the wireless communication device. And in additional and/or alternative scenarios, the processing circuitry may transmit, via the transceiver, an indication corresponding to at least one of: the DL data, or the relay data.

In another aspect, a method of wireless communication operable at a relay device is provided. The method includes receiving, over a first radio link, a first portion of at least one data flow from a scheduling entity, the first portion of the at least one data flow including relay data. In some scenarios, the method further includes determining an allocation of communication resources relative to a physical layer associated with the relay device, the relay device configured to utilize the physical layer for communicating the relay data to at least one destination device. And in additional and/or alternative scenarios, the method includes transmitting, via the allocation of communication resources of the physical layer, the relay data to the at least one destination device over a second radio link, the relay data associated with downlink (DL) data destined for the at least one destination device over a third radio link between the at least one device and the scheduling entity.

In another aspect, a wireless communication device is provided. The device includes a memory, and processing circuitry coupled to the memory. In some scenarios, the device, via at least the processing circuitry. In some scenarios, the processing circuitry may receive, over a first radio link, a first portion of at least one data flow from a scheduling entity, the first portion of the at least one data flow including relay data. And in additional and/or alternative scenarios, the processing circuitry may transmit, via a physical layer associated with the wireless communication device, the relay data to at least one device over a second radio link, the relay data associated with downlink (DL) data destined for the at least one device over a third radio link between the at least one device and the scheduling entity.

In another aspect, a method of wireless communication operable at a first device (e.g., a base station, a road side unit (RSU), etc.) is provided. The method includes transmitting at least one indication to at least one second device, the at least one indication configured to indicate that the at least one second device is to monitor for at least one data flow over: at least one first radio link, and at least one second radio link. In some scenarios, the method further includes transmitting, to the at least one second device via a physical layer associated with the first device, a first portion of the at least one data flow over the at least one first radio link, the first portion of the at least one data flow including downlink (DL) data for the at least one second device. The method further includes, in some scenarios, transmitting, to at least one third device via the physical layer associated with the first device, a second portion of the at least one data flow over the at least one second radio link, the second portion of the at least one data flow including relay data for the at least one second device. And in additional and/or alternative scenarios, the method includes receiving an indication corresponding to at least one of: the DL data or the relay data.

In another aspect, the present disclosure provides a method of wireless communication operable at a first device (e.g., a destination user equipment (UE)). The method includes receiving, from an upstream node (e.g., a network scheduling entity, etc.), an indication (e.g., a control message, a request, etc.) configured to indicate the first device is to monitor at least a first and second radio link for a data flow from the upstream node. In some scenarios, the first radio link can be configured as a link between the first device and the upstream node. And in additional and/or alternative scenarios, the second radio link can be configured as a link between the first device and a second device. The first device monitors the first radio link for a first portion of the data flow and monitors the second radio link for a second portion of the data flow. The method further includes the first device receiving at least the first portion of the data flow (including downlink (DL) data for the first device) or the second portion of the data flow (including relay data for the first device), and transmitting an acknowledgment message corresponding to the DL data or the relay data.

In another aspect, the present disclosure provides a method of wireless communication operable at a relay device (e.g., a relay user equipment (UE)). The method of wireless communication includes receiving, over a first radio link, a first portion of at least one data flow from an upstream scheduling entity, the first portion of the at least one data flow including relay data for at least one downstream device. In some scenarios, the method further includes determining an allocation of communication resources relative to a physical layer of the relay device to utilize for communicating the relay data to the at least one downstream device. And in additional and/or alternative scenarios, the method includes transmitting, via the physical layer of the relay device, the relay data to the at least one downstream device over a second radio link, the relay data being related to downlink (DL) data destined for the downstream device over a third radio link between the downstream device and the upstream scheduling entity.

In another aspect, the present disclosure provides a method of wireless communication operable at a network device. The method includes transmitting at least one control message to at least one second device indicating the at least one second device is to monitor for at least one data flow over: at least one first radio link, and at least one second radio link, and includes transmitting, to the at least one second device via a physical layer of the first device, a first portion of the at least one data flow over the at least one first radio link, the first portion of the at least one data flow including downlink (DL) data for the at least one second device. In some scenarios, the method further includes transmitting, to at least one third device via the physical layer of the first device, a second portion of the at least one data flow over the at least one second radio link, the second portion of the at least one data flow including relay data for the at least one second device related to the DL data for the at least one second device, the at least one third device being interposed between the first device and the at least one second device. And in additional and/or alternative scenarios, the method includes receiving an acknowledgment message corresponding to at least one of: the DL data or the relay data.

In another aspect, a wireless communication device is provided. The device includes a memory, and processing circuitry coupled to the memory, and configured to receive, from at least one upstream scheduling entity, a control message indicating the first device is to monitor at least one first radio link and at least one second radio link for at least one data flow from the at least one upstream scheduling entity over: the at least one first radio link between the first device and the at least one upstream scheduling entity, and the at least one second radio link between the first device and at least one second device. In some scenarios, the processing circuitry may monitor the at least one first radio link for a first portion of the at least one data flow, and/or to monitor the at least one second radio link for a second portion of the at least one data flow. In additional and/or alternative scenarios, the processing circuitry may receive at least one of: the first portion of the at least one data flow including downlink (DL) data for the first device, or the second portion of the at least one data flow including relay data for the first device. And in additional and/or alternative scenarios, the processing circuitry may transmit an indication corresponding to at least one of: the DL data or the relay data.

In another aspect, a wireless communication device includes means for receiving, from at least one upstream scheduling entity, a control message indicating the first device is to monitor at least one first radio link and at least one second radio link for at least one data flow from the at least one upstream scheduling entity over: the at least one first radio link between the first device and the at least one upstream scheduling entity, and the at least one second radio link between the first device and at least one second device. In some scenarios, the wireless communication device further includes means for monitoring the at least one first radio link for a first portion of the at least one data flow, and means for monitoring the at least one second radio link for a second portion of the at least one data flow. In additional and/or alternative scenarios, the wireless communication device includes means for receiving at least one of: the first portion of the at least one data flow including downlink (DL) data for the first device, or the second portion of the at least one data flow including relay data for the first device. And in additional and/or alternative scenarios, the wireless communication device includes means for transmitting an indication corresponding to at least one of: the DL data or the relay data.

In a further aspect, the present disclosure provides a non-transitory computer-readable medium storing computer-executable code. The computer-executable code includes code for causing a wireless communication device to receive, from at least one upstream scheduling entity, a control message indicating the first device is to monitor at least one first radio link and at least one second radio link for at least one data flow from the at least one upstream scheduling entity over: the at least one first radio link between the first device and the at least one upstream scheduling entity, and the at least one second radio link between the first device and at least one second device. In some scenarios, the computer-executable code further includes code for causing the wireless communication device to monitor the at least one first radio link for a first portion of the at least one data flow, and/or to monitor the at least one second radio link for a second portion of the at least one data flow. In additional and/or alternative scenarios, the computer-executable code includes code for causing the wireless communication device to receive at least one of: the first portion of the at least one data flow including downlink (DL) data for the first device, or the second portion of the at least one data flow including relay data for the first device. And in additional and/or alternative scenarios, the computer-executable code includes code for causing the wireless communication device to transmit an indication corresponding to at least one of: the DL data or the relay data.

In another aspect, a wireless communication device is provided. The device includes processing circuitry (e.g., one or more processors), a transceiver communicatively coupled to the processing circuitry, and a memory communicatively coupled to the processing circuitry. In some scenarios, the processing circuitry and the memory may receive, over a first radio link, a first portion of at least one data flow from an upstream scheduling entity, the first portion of the at least one data flow including relay data for at least one downstream device. In some scenarios, the processing circuitry are further configured to determine an allocation of communication resources relative to a physical layer of the relay device to utilize for communicating the relay data to the at least one downstream device. And in additional and/or alternative scenarios, the processor and the memory are configured to transmit, via the physical layer of the relay device, the relay data to the at least one downstream device over a second radio link, the relay data being related to downlink (DL) data destined for the downstream device over a third radio link between the downstream device and the upstream scheduling entity.

In another aspect, a wireless communication device includes means for receiving, over a first radio link, a first portion of at least one data flow from an upstream device (e.g., at least one upstream scheduling entity), the first portion of the at least one data flow including relay data for at least one downstream device. In some scenarios, the wireless communication device further includes means for determining an allocation of communication resources relative to a physical layer of the relay device to utilize for communicating the relay data to the at least one downstream device. And in additional and/or alternative scenarios, the wireless communication device includes means for transmitting, via the physical layer of the relay device, the relay data to the at least one downstream device over a second radio link, the relay data being related to downlink (DL) data destined for the downstream device over a third radio link between the downstream device and the upstream device.

In a further aspect, the present disclosure provides a non-transitory computer-readable medium storing computer-executable code. The computer-executable code includes code for causing a wireless communication device to receive, over a first radio link, a first portion of at least one data flow from an upstream scheduling entity, the first portion of the at least one data flow including relay data for at least one downstream device. In some scenarios, the computer-executable code further includes code for causing the wireless communication device to determine an allocation of communication resources relative to a physical layer of the relay device to utilize for communicating the relay data to the at least one downstream device. And in additional and/or alternative scenarios, the computer-executable code includes code for causing the wireless communication device to transmit, via the physical layer of the relay device, the relay data to the at least one downstream device over a second radio link, the relay data being related to downlink (DL) data destined for the downstream device over a third radio link between the downstream device and the upstream scheduling entity.

In another aspect, a wireless communication device is provided. The device includes a processor, a transceiver communicatively coupled to the processor, and a memory communicatively coupled to the processor. The processor and the memory (e.g., in coordination with memory, buffer memory, etc.) are configured to transmit at least one control message to at least one second device (e.g., a destination user equipment (UE)) indicating the at least one second device is to monitor for at least one data flow over: at least one first radio link, and at least one second radio link. In some scenarios, the wireless communication device is further configured to transmit, to the at least one second device via a physical layer of the first device, a first portion of the at least one data flow over the at least one first radio link, the first portion of the at least one data flow including downlink (DL) data for the at least one second device, and to transmit, to at least one third device via the physical layer of the first device, a second portion of the at least one data flow over the at least one second radio link, the second portion of the at least one data flow including relay data for the at least one second device related to the DL data for the at least one second device, the at least one third device being interposed between the first device and the at least one second device. And in additional and/or alternative scenarios, the processor and the memory are configured to receive an indication corresponding to at least one of: the DL data or the relay data.

In another aspect, a wireless communication device includes means for indicating to a destination device that the destination device is to monitor for a data flow over: at least one first radio link, and at least one second radio link, and means for transmitting, to the at least one second device via a physical layer of the first device, a first portion of the at least one data flow over the at least one first radio link, the first portion of the at least one data flow including downlink (DL) data for the at least one second device. In some scenarios, the wireless communication device further includes means for transmitting, to at least one third device via the physical layer of the first device, a second portion of the at least one data flow over the at least one second radio link, the second portion of the at least one data flow including relay data for the at least one second device related to the DL data for the at least one second device, the at least one third device being interposed between the first device and the at least one second device. And in additional and/or alternative scenarios, the wireless communication device includes means for receiving an indication corresponding to at least one of: the DL data or the relay data.

In a further aspect, the present disclosure provides a non-transitory computer-readable medium storing computer-executable code. The computer-executable code includes code for causing a wireless communication device to provide an indication (e.g., via at least one control message) to at least one second device indicating the at least one second device is to monitor for at least one data flow over: at least one first radio link, and at least one second radio link, and to transmit, to the at least one second device via a physical layer of the first device, a first portion of the at least one data flow over the at least one first radio link, the first portion of the at least one data flow including downlink (DL) data for the at least one second device. In some scenarios, the computer-executable code further includes code for causing the wireless communication device to transmit, to at least one third device via the physical layer of the first device, a second portion of the at least one data flow over the at least one second radio link, the second portion of the at least one data flow including relay data for the at least one second device related to the DL data for the at least one second device, the at least one third device being interposed between the first device and the at least one second device. And in additional and/or alternative scenarios, the computer-executable code includes code for causing the wireless communication device to receive an indication corresponding to at least one of: the DL data or the relay data.

These and other aspects of the technology discussed herein will become more fully understood upon a review of the detailed description, which follows. Other aspects, features, and examples will become apparent to those in the art, upon reviewing the following description of specific examples in conjunction with the accompanying figures. While the following description may discuss various advantages and features relative to certain embodiments and figures, all embodiments can include one or more of the advantageous features discussed herein. In other words, while this description may discuss one or more examples as having certain advantageous features, one or more of such features may also be used in accordance with the various examples discussed herein. In similar fashion, while this description may discuss exemplary embodiments as device, system, or method embodiments, it should be understood that such exemplary embodiments can be implemented in various devices, systems, and methods.

### BRIEF DESCRIPTION OF THE DRAWINGS

FIG. 1 is a schematic illustration of a wireless communication system according to some examples.

FIG. 2 is a conceptual illustration of an example of a radio access network according to some examples.

FIG. 3 is a block diagram illustrating a wireless communication system supporting multiple-input multiple-output (MIMO) communication according to some examples.

FIG. 4 is a schematic illustration of an organization of wireless resources in an air interface utilizing orthogonal frequency divisional multiplexing (OFDM) according to some examples.

FIG. 5 is a schematic illustration of a communication network including various scheduled entities and at least one upstream scheduling entity according to some examples.

FIG. 6 is a schematic illustration of a communication network including scheduled entities and at least one scheduling entity upstream relative to the scheduled entities according to some examples.

FIG. 7 is a schematic illustration of a communication network including a first user equipment (UE) and a second UE in a UE group according to some examples.

FIG. 8 is a flow chart illustrating an exemplary process usable by a scheduling entity for communicating data between the scheduling entity and a destination device according to some examples.

FIG. 9 is a flow chart illustrating an exemplary process usable by a scheduling entity to identify a suitable relay UE for serving as a relay device according to some examples.

FIG. 10 is a schematic illustration of an upstream node (e.g., a network element, scheduling entity, etc.) transmitting a data flow to a destination UE in a relay configuration according to some examples.

FIG. 11 is a flow chart illustrating an exemplary process for transmitting data from an upstream scheduling entity to a destination UE according to some examples.

FIG. 12 is a flow chart illustrating an exemplary process for receiving and transmitting relay data to a destination UE in a second portion of a data flow according to some examples.

FIG. 13 is a flow chart illustrating an exemplary process usable by a scheduled entity to communicate with an upstream scheduling entity and relaying entity according to some examples.

FIG. 14 is a flow chart illustrating an exemplary process usable by a scheduled entity to communicate with a primary scheduling entity and a relaying entity interfacing with the primary scheduling entity according to some examples.

FIG. 15 is a block diagram conceptually illustrating an example protocol stack for an example scheduled entity and an example scheduling entity according to some examples.

FIG. 16 is a schematic illustration of a network device transmitting a data flow to a destination UE over a plurality of radio links according to some examples.

FIG. 17 is a block diagram conceptually illustrating an example of a hardware implementation for a scheduled entity according to some examples.

FIG. 18 is a block diagram conceptually illustrating an example of a hardware implementation for a scheduling entity according to some examples.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, and/or packaging arrangements. In an example, embodiments and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices and systems incorporating one or more aspects of the disclosed technology. In some practical settings, devices incorporating described aspects and features may also necessarily include additional components and features for implementation and practice of claimed and described embodiments. In an example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, aggregated or dis-aggregated, end-user devices, etc. of varying sizes, shapes and constitution.

Techniques presented herein aim to provide several approaches and features. In one aspect, the present disclosure provides a method of wireless communication operable at a first device (e.g., a user equipment (UE), a road side unit (RSU), etc.). In some scenarios, the first device monitors for the at least one data flow from the at least one upstream node. In an example, the method of wireless communication includes receiving an indication from at least one upstream node (e.g., a scheduling entity). Accordingly, the indication can be configured to indicate, upon being received, that the first device is to monitor a plurality of radio links for at least one data flow. In some examples, the indication may include an explicit indication, where the scheduling entity explicitly identifies, for the destination UE, the plurality of radio links that the destination UE is to monitor for the data flow. In another example, the indication may include an implicit indication, where the destination UE can be configured to imply which radio links the destination UE is to monitor to receive the data flow. In some examples, the indication can include a control message, a request message for channel state information (CSI) relative to potential relay communication paths, and so forth. The plurality of radio links may include at least one first radio link and at least one second radio link.

In some examples, the first device monitors a plurality of radio links to receive the data flow from a network scheduling entity (e.g., a base station (BS)) or other network element. In accordance with the indication, the first device may monitor for the data flow over: the at least one first radio link between the first device and the at least one upstream scheduling entity, and the at least one second radio link between the first device and at least one second device. In some scenarios, the method further includes monitoring the at least one first radio link for a first portion of the at least one data flow, and/or monitoring the at least one second radio link for a second portion of the at least one data flow.

In additional and/or alternative scenarios, the method may further include receiving at least one of: the first portion of the at least one data flow including DL data for the first device, or the second portion of the at least one data flow including relay data for the first device. And in additional and/or alternative scenarios, the method may include transmitting an acknowledgment message corresponding to at least one of: the DL data or the relay data. Person of skill in the art will understand these example method actions, among other example techniques disclosed, can be used in additive and/or alternative combinations and permutations in accordance with one or more of the various techniques of this disclosure.

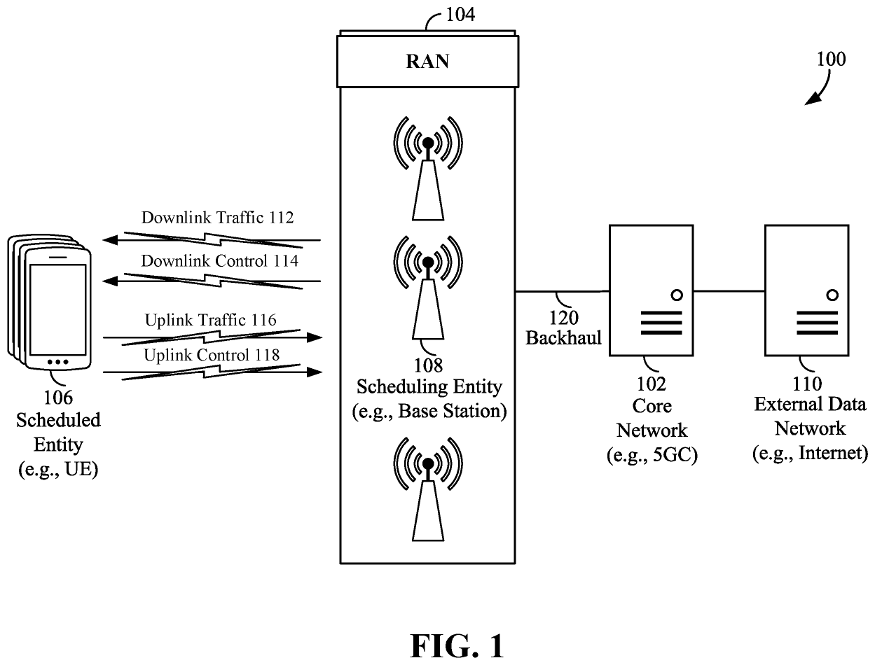

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to facilitate communication between a UE 106 and a scheduling entity 108 (e.g., by providing radio access to the UE 106). In an example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

NR access may support various wireless communication services. This can include enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

As illustrated, the RAN 104 includes at least one scheduling entity 108, where in some examples, the scheduling entity 108 may be a base station (e.g., a gNB). Broadly, a base station (BS) is a network element in a radio access network that provides radio transmission and reception in one or more cells to or from a scheduled entity 106 (e.g., a UE). In different technologies, standards, or contexts, those skilled in the art may variously refer to a base station as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quadcopter, a remote control device, a consumer and/or wearable device, such as eyewear, a wearable camera, a heads-up display, an extended reality (XR)-enabling device (e.g., a virtual reality (VR) device), a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or for relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this technique may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106). As illustrated in FIG. 1, a scheduling entity 108 may manage DL traffic 112 to one or more scheduled entities 106, and UL traffic 116 from one or more scheduled entities 106.

In some examples, access to the air interface may be scheduled. This can include where a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108. In an example, the scheduled entities 106 may include entities (e.g., UEs) scheduled for communication that are configured to utilize resources allocated by the scheduling entity 108.

Base stations (BSs) are not the only entities that may function as scheduling entities. That is, in some examples, a UE may function as a scheduling entity 108, scheduling resources for one or more scheduled entities (e.g., one or more other UEs) in wireless communication system 100.

As illustrated in FIG. 1, a scheduling entity 108 may broadcast downlink (DL) traffic 112 to one or more scheduled entities 106. Broadly, the scheduling entity 108 is a node or device responsible for scheduling traffic in a wireless communication network, including the DL traffic 112 and, in some examples, uplink (UL) traffic 116 from one or more scheduled entities 106 to the scheduling entity 108. On the other hand, the scheduled entity 106 is a node or device that receives DL control information (DCI) 114, including but not limited to scheduling information (e.g., a grant), synchronization or timing information, or other control information from another entity in the wireless communication network (e.g., from a scheduling entity 108).

In general, scheduling entities 108 (e.g., base stations (BSs)) may include a backhaul interface for communication with a backhaul 120 of the wireless communication system 100. The backhaul 120 may provide a link between a scheduling entity 108 and a core network 102. Further, in some examples, a backhaul 120 may provide interconnection between multiple scheduling entities 108 (e.g., between a first BS and a second BS, etc.). Various types of interfaces for the backhaul 120 may be employed, such as a direct physical connection, a virtual network, or the like using any suitable transport network.

The core network 102 may be a part of the wireless communication system 100, and may be independent of the radio access technology (RAT) used in the RAN 104. In some examples, the core network 102 may be configured according to NR specifications (e.g., 5GC). In another example, the core network 102 may be configured according to a 4G evolved packet core (EPC), or any other suitable standard or configuration.

The techniques described herein may be used for various wireless networks and radio technologies. While some aspects of the present disclosure may be described using terminology commonly associated with 3G, 4G, and/or new radio (e.g., 5G NR) wireless technologies, aspects of the disclosed technology can be applied in other generation-based communication systems as would be understood by a person skilled in the art.

In general, any number of wireless networks may be deployed in a given geographic area. Each wireless network may support a particular radio access technology (RAT) and may operate on one or more frequencies. Those skilled in the art may variously refer to a RAT as a radio technology, an air interface, etc. Those skilled in the art may further refer to a frequency as a carrier, a subcarrier, a frequency channel, a component carrier, a tone, a subband, etc. Each frequency may support a single RAT in a given geographic area in order to avoid interference between wireless networks of different RATs.

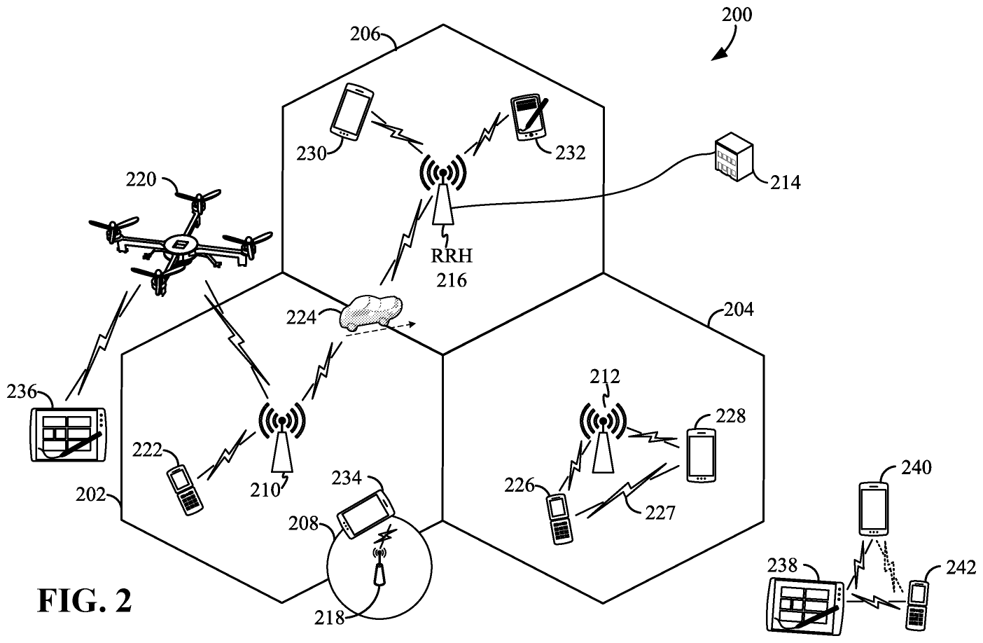

FIG. 2 provides a schematic illustration of a radio access network (RAN) 200, by way of example and without limitation. In some examples, the RAN 200 may be the same as the RAN 104 described, for example, with reference to FIG. 1. For example, the RAN 200 may be an NR system (e.g., a 5G NR network). The RAN 200 may be in communication with a core network 102. The core network 102 may be in communication with one or more BSs 210, 212, 214, and/or 218 and/or UEs 222, 224, 226, 228, 230, 232, 234, 236, 238, 240, and/or 242 in the RAN 200 via one or more interfaces.

The geographic area covered by the RAN 200 may be divided into cellular regions (cells) that a user equipment (UE) can uniquely identify based on an identification broadcasted from an access point or scheduling entity 108 (e.g., a base station). FIG. 2 illustrates macro cells 202, 204, and 206, and a small cell 208, each of which may include one or more sectors (not shown). A sector is generally a sub-area of a cell. In some examples, a particular scheduling entity 108 may serve each sector included within a given cell. A communication link within a sector can be identified by a single logical identification belonging to that sector. In a cell that is divided into sectors, the multiple sectors within a cell can be formed by sets of antennas.

FIG. 2 shows two base stations (BSs) 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 126 may be referred to as macro cells, as the BSs 210, 212, and 214 support cells having a large size. Further, a base station 218 is shown in the small cell 208 which may overlap with one or more macro cells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network 102 for any number of mobile apparatuses. In some examples, the base stations 210, 212, 214, and/or 218 may correspond to one or more of the scheduling entities 108 described, for example, with reference to FIG. 1.

FIG. 2 further includes a quadcopter or drone 220, which may be configured to function as a scheduling entity 108 (e.g., a base station). That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point (AP) to a core network 102 (e.g., via a network controller) for the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described, for example, with reference to FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer-to-peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), P2P, or vehicle-to-vehicle (V2V) network, and/or in a mesh network. In a mesh network example, UEs 240 and 242 may communicate directly with one another in addition, or alternatively, to communicating with the scheduling entity 238. In an example, a mesh network may include a configuration of three or more UEs communicating directly with one another, where in such instances, one or more of the UEs may operate as a scheduling entity for the other UEs, similarly to how a plurality of UEs may be communicating with a base station as the scheduling entity for the UEs. That is, in a wireless communication system 100 with scheduled access to time-frequency resources and having a cellular configuration, a P2P configuration, or a mesh configuration, a scheduling entity and one or more scheduled entities may communicate utilizing the scheduled resources.

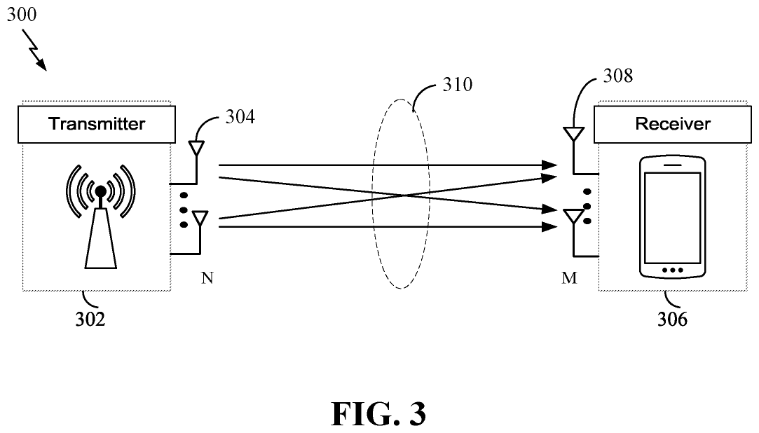

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In one example case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank (and therefore, a number of data streams) for a DL transmission to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In Time Division Duplex (TDD) systems, the UL and DL may be reciprocal, in that each uses different time slots of the same frequency bandwidth. Therefore, in TDD systems, a transmitter 302 may assign a rank for DL MIMO transmissions based on an UL SINR measurement (e.g., based on a sounding reference signal (SRS) or other pilot signal transmitted from the receiver 306). Based on the assigned rank, the transmitter 302 may then transmit a channel state information reference signal (CSI-RS) with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the rank and assigning resources for future DL transmissions.

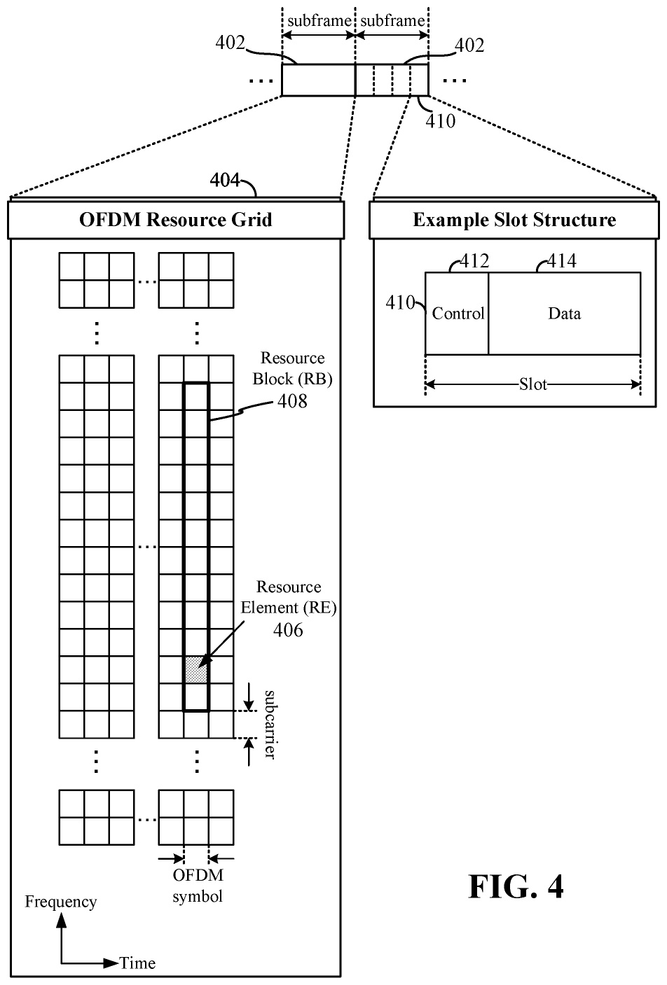

FIG. 4 schematically illustrates various aspects of the present disclosure with reference to an OFDM waveform. Those of skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the uplink (UL), and another set of frames in the downlink (DL). FIG. 4 illustrates an expanded view of an exemplary DL subframe 402, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and may contain a single complex value representing data from a physical channel or signal. Depending on the modulation utilized in a particular implementation, each resource element (RE) may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB such as the RB 308 entirely corresponds to a single direction of communication (either transmission or reception for a given device).

A UE generally utilizes only a subset of the resource grid 304. An RB may be the smallest unit of resources that a scheduler can allocate to a UE. Thus, the more RBs scheduled for a UE, and the higher the modulation technique chosen for the air interface, the higher the data rate for the UE.

In this illustration, the RB 408 occupies less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Subframes may have a variety of features that may be configurable. In some examples, subframes may have a fixed duration or length or configurable duration or length. In some examples, a subframe can be 1 millisecond (ms). In some scenarios, each 1 ms subframe 402 may consist of one or multiple adjacent slots (e.g., a series of consecutive slots). In FIG. 4, one subframe 402 includes four slots 410, as an illustrative example. In some examples, a slot may be defined according to a specified number of orthogonal frequency division multiplexing (OFDM) symbols with a given cyclic prefix (CP) length. For example, a slot may include 7 or 14 OFDM symbols with a nominal CP. Additional examples may include mini-slots having a shorter duration (e.g., one or two OFDM symbols). A scheduling entity 108 (e.g., a base station) may, in some cases, transmit these mini-slots occupying resources scheduled for ongoing slot transmissions for the same or for different scheduled entities 106.

An expanded view of one of the slots 410 illustrates the slot 410 including a control region 412 and a data region 414. In general, the control region 412 may carry control channels (e.g., PDCCH), and the data region 414 may carry data channels (e.g., physical downlink shared channel (PDSCH) or physical uplink shared channel (PUSCH)). Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not explicitly illustrated in FIG. 4, the various REs 406 within an RB 408 may carry one or more physical channels, including control channels, shared channels, data channels, etc. Other REs 406 within the RB 408 may also carry pilots or reference signals (RSs). These pilots or reference signals may provide for a receiving device to perform channel estimation of the corresponding channel, which may enable coherent demodulation/detection of the control and/or data channels within the RB 408.

In a downlink (DL) transmission, the transmitting device (e.g., a scheduling entity 108) may allocate one or more resource elements (REs) 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. The PDCCH may carry downlink control information (DCI) 114 for one or more UEs in a cell. This can include, but is not limited to, power control commands, scheduling information, a grant, and/or an assignment of REs for DL and/or UL transmissions.

Further, the transmitting device (e.g., a scheduling entity 108) may allocate a portion of a slot's resources (e.g., one or more REs) to carry physical signals that generally do not carry information originating from higher layers. These physical signals may include a primary synchronization signal (PSS); a secondary synchronization signal (SSS); demodulation reference signals (DM-RSs); phase-tracking reference signals (PT-RSs); channel state information reference signals (CSI-RSs); etc. In such examples, communication resources (e.g., REs) may be allocated to carry such physical signals.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106). may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RSs), phase-tracking reference signals (PT-RSs), sounding reference signals (SRSs), etc. In some examples, the UCI 118 may include a scheduling request (SR) (e.g., a request for the scheduling entity 108 to schedule uplink transmissions). In such examples, the scheduling entity 108 may, in response to the SR transmitted on the UL control channel (e.g., a PUCCH), transmit downlink control information (DCI) 114 that may schedule resources for uplink packet transmissions.

The uplink (UL) control information (UCI) may also include hybrid automatic repeat request (HARQ) feedback such as an acknowledgment (ACK) or negative acknowledgment (NACK), channel state information (CSI), or any other suitable UL control information (UCI). HARQ is a technique well-known to those in the art, wherein a receiving device can check the integrity of packet transmissions for accuracy, e.g., utilizing any suitable integrity checking mechanism, such as a checksum or a cyclic redundancy check (CRC). If the receiving device (e.g., a scheduled entity 106) confirms the integrity of the transmission, the receiving device may transmit an ACK to the transmitting device (e.g., a scheduling entity 108). If the receiving device is unable to confirm the integrity of the transmission, the receiving device may transmit a NACK. In response to a NACK, the transmitting device may send a HARQ retransmission, which may implement chase combining, incremental redundancy, etc.

In addition to downlink control information (DCI), a scheduling entity 108 may allocate one or more REs 406 (e.g., within the data region 414) for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above and illustrated in FIGS. 1 and 4 are not necessarily all the channels or carriers that may be utilized between a scheduling entity 108 and scheduled entities 106. Those of ordinary skill in the art will recognize that other channels or carriers may be utilized in addition to those illustrated, such as other traffic, control, and feedback channels.

### User Equipment Groups

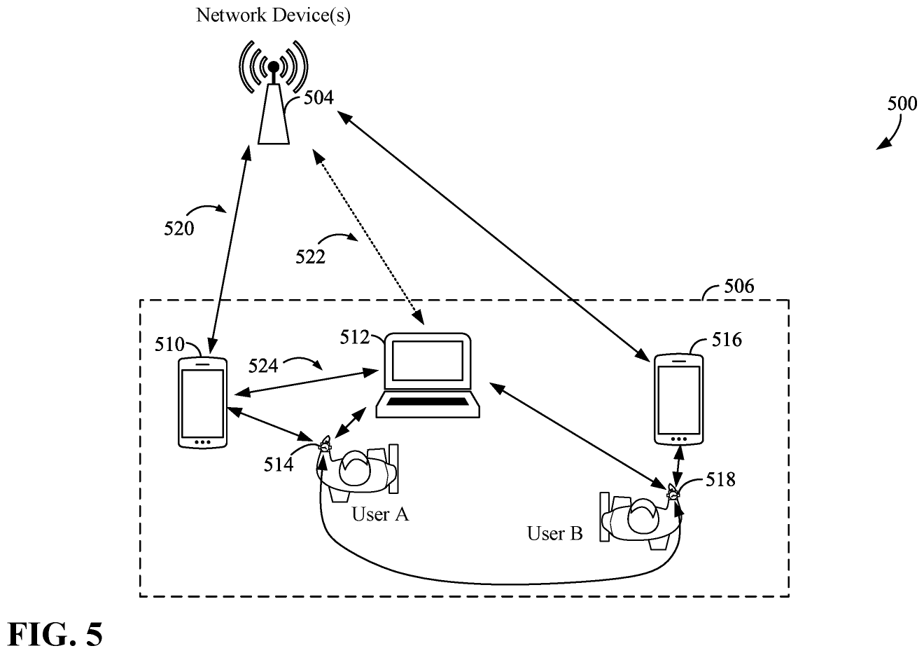

FIG. 5 provides a schematic illustration of a communication network 500 including various scheduled entities 106 and at least one scheduling entity 108. The communication network 500 may be an example of part of a communication network 100 described with reference to FIG. 1. In an example, the communication network 500 may represent a radio access network (RAN), such as the RAN 104/200 described with reference to FIGS. 1 and 2, for example.

In some examples, the communication network 500 may include one or more network device(s) 504. In an example, the network device(s) 504 may represent a set of one or more scheduling entities 108 of communication network 500. In such examples, a network device 504 may include a network element, such as a base station (e.g., a gNB, eNB, etc.), a road side unit (RSU), or some other scheduling entity 108.

In some examples, the communication network 500 may include a plurality of scheduled entities 106. In an example, the scheduled entities 106 of communication network 500 may include a set of UEs 510, 512, 514, 516, 518, etc.

In some examples, the scheduled entities may include one or more UEs that receive downlink control information (DCI) from an upstream node or scheduling entity 108 (e.g., the network device(s) 504). In another example, a first UE 510) may transmit and/or receive control information to/from a second UE 512). In an example, a first UE 510 may communicate sidelink (SL) control information (SCI) (e.g., control information for a sidelink (SL), a local area network (LAN) connection, etc.) with a second UE 512 via a communication link (e.g., the communication link 524). In some instances, the communication link can include a radio link, such as an SL radio link. In such examples, the first UE 510 may utilize the DCI, or other communication protocol messages, to communicate with the second UE 512 over the communication link 524. In an illustrative and non-limiting example, a first UE 510 may implement so-called PC5 signaling protocol procedures (e.g., a sidelink) to transmit a request message to another UE (e.g., UE 512, UE 514, UE 518, etc.) to initiate the other UE as being a destination device for data or to initiate the other UE as part of a chain of UEs transmitting data to a destination device. In any event, the first UE 510 may transmit data to, and/or receive data from, the second UE 512 via the communication link 524.

While some examples herein may discuss one UE transmitting data to another UE utilizing a radio link (e.g., a sidelink), the techniques of this disclosure are not so limited, and a communication link between any two UEs may additionally or alternatively include one or more various other communication links, such as a wired link and/or another wireless link. In an example, the communication link 524 may be a Bluetooth connection linking a first UE 510 and a second UE 522. In such instances, the UEs 106 may utilize separate radio links (e.g., radio link 520, radio link 522, etc.). The UE(s) 106 may utilize the separate radio links to communicate with additional elements of the communication network 500 (e.g., a set of network device(s), etc.).

In some examples, the set of network devices 504 (e.g., a plurality of base stations (BSs), etc.) may be effectively positioned upstream relative to one or more scheduled entities (e.g., a set of UEs, a set of virtual UEs, a set of UE groups, etc.). In an example, the network device 504 (e.g., a BS) may communicate with a group of UEs using one or more radio links established between the UEs within the UE group 506. In an illustrative example, a BS may generate data for UE 510, and transmit the data downstream toward the UE 510 via a downlink (DL) transmission on radio link 520.

In some examples, an upstream device, in the context of this disclosure, generally refers to an entity that is included in a set of network device(s) 504, such as a base station 108 or another network element of the communication network 500. Additionally and/or alternatively, an upstream device generally refers to a device (e.g., a relay UE) configured to relay data along a communication path as between the set of network devices 504 and a given destination UE 106. Likewise, a downstream device, in the context of this disclosure, generally refers to a device that transmits data to the set of network device(s) 504.

In some examples, a downstream device (e.g., a destination UE 106) can be configured to transmit data directly to the set of network device(s) 504. In another example, a downstream device (e.g., a destination UE 106) can be configured to transmit data to the set of network device(s) 504 indirectly via an intermediary, such as an upstream relay UE. In an example, the upstream relay UE may include a road side unit (RSU) or a UE 106. In some examples, a downstream device may include a destination UE 106 configured to receive downlink (DL) data and/or relay data from the set of network device(s) 504. In an illustrative example and non-limiting example, a first downstream device may include a destination UE, a destination RSU, or any other entity configured to transmit data to the set of network device(s) 504. In additional and/or alternative scenarios, an upstream device may include a network element, an RSU, a UE, or any other entity included in the set of network device(s) 504 or configured to relay data, via a relay radio link, to a downstream device, such as a destination UE 106.

In an illustrative and non-limiting example, the network device 504 is upstream relative to one or more UEs that can receive and/or transmit data to or from the network device 504, either directly or indirectly via an intermediary. In another illustrative and non-limiting example, UE 510, UE 512, and UE 514 are all downstream of network device 504. In addition, UE 514 is downstream from UE 510 or UE 512 depending on whether UE 510 or UE 512 is serving as an intermediary for UE 514 to communicate with network device 504. Furthermore, UE 510 may be referred to as upstream from UE 512, in instances where UE 512 communicates with network device 504 via the first link 520, the second link 524, e.g., when not utilizing radio link 522 to communicate with network device 504 and/or when radio link 522 is nonexistent.

In some examples, devices of the communication network 500 (e.g., network device(s) 504, a scheduled entity 106, etc.) may determine information relative to a set of UEs 106. In an example, devices of the communication network 500 may systematically exchange certain information relative to a set of UEs. In such examples, the devices of the communication network 500 may exchange such UE-related information to advantageously define (e.g., classify, form) a set of UEs 106 as being part of a UE group 506.

In some examples, an upstream scheduling entity 108 may receive a group indication from one or more UEs 106 (e.g., UE 510, UE 512, UE 516, etc.). The group indication can be configured to indicate the various UEs 106 for defining into a particular UE group 506. In addition, or alternatively, the upstream scheduling entity (e.g., network devices(s) 504) may receive and/or transmit downlink (DL) signals to one or more UEs. Based on UE information that the network device(s) 504 determines from the one or more UEs regarding a set of UEs, the network device(s) 504 may determine the set of UEs define a UE group 506. In some scenarios, the network device(s) 504 can be configured to communicate with the UE group 506 as a collective set of UEs. In additional and/or alternative scenarios, the network device(s) 504 can be configured to communicate with the set of UEs, within the UE group 506, as individual UEs 106.

In an illustrative example, the network devices 504 may determine and/or track the identities of certain UEs 106. In an example, the network device 504 may identify and track all UEs connected to a single Wi-Fi network or other network visible to the network device 504 from within communication network 500. In another example, the network device 504 may identify and track all UEs within a geofence or other location-based structure. In addition, or alternatively, the network device 504 may identify and/or track UEs possessing certain attributes. In an example, the network device 504 may identify UE attributes linking a set or a subset of UEs to a specific set of users (e.g., User A, User B, etc.). In another example, the network device 504 may identify UE attributes linking a set of UEs to a specific network operating within or in tandem with communication network 500, and so forth. In some examples, the network device 504 may utilize such UE attributes as UE information for defining a set of UEs as being part of a UE group 506.

In some examples, the UEs within UE group 506 may access a separate communication network (e.g., a communication subnetwork). The separate communication network may operate within or in tandem with the communication network 500. The UEs may do so via a Wi-Fi or other protocol-based connection. In an example, the UEs may interface with and/or operate within a communication network that is detached (e.g., disconnected) from the communication network 500. In an illustrative example, the UEs may communicate with one another using a particular wireless communication protocol (e.g., Bluetooth, etc.) that is disconnected from the communication network 500 even if only disconnected temporarily (e.g., intermittently) based on a network configuration and/or various other environmental circumstances of the communication network 500. In some examples, the UEs 106 may access the separate communication network via a wired connection (e.g., a local area network (LAN), a personal area network (PAN), etc.).

In some examples, the UE 106 may provide UE information in the form of authentication credentials. In an example, the UE 106 may provide authentication credentials to gain access to the network. In some examples, the authentication credentials may include a password, biometric information, geolocation information, username, and/or other credential-related data items. In an example, a UE 106 may provide authentication credentials to access the communication network 500 as a whole (e.g., a gatekeeper password). In another example, the UE 106 may provide authentication credentials to access one or more subnetworks.

In some examples, the one or more subnetworks may operate within or in tandem with the communication network 500. In such scenarios, the UE 106 can be configured to transmit authentication credentials via one or more radio links. In some examples, the UE 106 may provide one or more devices with a set of authentication credentials. In one scenario, the UE 106 may provide authentication credentials to one or more other UEs 106. In such scenarios, the UEs 106 may be operating within or in tandem with the communication network 500. In additional and/or alternative scenarios, the UE 106 may provide authentication credentials to one or more network device(s) 504 (e.g., one or more base stations (BSs)). Similarly, the one or more network device(s) 504 may be operating within or in tandem with the communication network 500.

Pursuant to validation of the authentication credentials of the UE 106, the UE 106 may be authorized to communicate with the one or more other UEs 106. In additional and/or alternative scenarios, the UE 106 may be similarly authorized and thus configured to communicate with the one or more network device(s) 504.

In an illustrative example, the UEs may, in certain instances, gain access to the communication network 500. Accordingly, the UEs may utilize radio links to transmit uplink (UL) communications to at least one upstream node (e.g., the network device 504 of FIG. 5). In addition, the UEs may receive downlink (DL) transmissions from the upstream scheduling entity 108.

In some examples, multiple users may possess and/or operate certain UE devices jointly with one another. In an illustrative and non-limiting example, such UEs may include examples such as common-area workstation computers, shared terminals, family vehicles, such as a car with operating patterns indicative of different identifiable users of the car, audio speaker systems, control hubs, and the like. In some examples, a first User A and a second User B may jointly occupy, possess, and/or otherwise share a same residence, office building, vehicle, or other location (e.g., real, virtual, etc.).

In an illustrative and non-limiting example, the first User A and the second User B may be office partners operating a business from within an office building. According to geolocation (e.g., geofencing) and/or other physical boundaries, the office building may include or bear some proximate relationship to various UEs belonging to or otherwise corresponding to User A, User B, and/or any number of additional users, as those users conduct themselves, for example, at the office or any other specified location. In another example, the office location and/or the UEs may include dedicated connectivity services (e.g., a local Wi-Fi network, a local area network (LAN), etc.) for enabling different types of communication between the UEs or other devices. Such dedicated connectivity services may track the identity of the UEs (e.g., based on device IDs, etc.) and/or the activity of UEs connected to the service. In such examples, the service may operate relative to a particular location proximate the UEs.

In some examples, a network device 504 may identify UE information for defining a UE group 506. In such examples, the UE information may be based upon a set of UEs 106. In such instances, the set of UEs 106 defining the UE group 506 may correspond to, for example, one or more specific users, one or more specified locations, one or more specified subnetworks, and so forth. In an illustrative and non-limiting example, the network device 504 and/or a UE 106 may define one or more UE group(s) 506 as including any UE 106 corresponding to both User A and User B (as shown in FIG. 5 with one UE group 506 including a first set of UEs 106). In additional and/or alternative examples, the network device 504 and/or the UE 106 may define one or more UE group(s) 506 to include any UE 106 corresponding to User A only (e.g., a smaller set of UEs 106; not explicitly shown in FIG. 5). Likewise, the network device 504 and/or the UE 106 may define one or more UE group(s) 506 to include any UE 106 corresponding to User B only (e.g., a third set of UEs 106), and so forth.

In instances where the UE 106 is tasked with providing UE information for grouping purposes, the UE 106 may transmit any relevant UE information (e.g., user profile information, location information, UE historical/behavior data, etc.) to the network device(s) 504 for such purposes. In an illustrative and non-limiting example, a UE 106 may transmit device identification (ID) information to the network device(s) 504 for such purposes. In an example, a UE 106 may identify a UE group 506 based on the destination layer identifiers corresponding to a set of UEs 106. That is, a set of UEs 106 may, in certain instances, share destination layer identifiers. Accordingly, the UE 106 may group the set of UEs 106 in a first UE group 506 based at least in part on the destination layer identifiers and/or based on any other UE information. As described herein, UEs 106 within a UE group 506 may operate in coordination with one another to implement one or more of the various relaying techniques of this disclosure.

In some examples, the one or more UE(s) 106 may instead define the UE group 506 according to one or more of the various techniques of this disclosure. In such instances, the one or more UEs 106 may provide the network device(s) 504 with UE information defining the UE group 506. In additional and/or alternative scenarios, a UE may further provide the UE information underlying the grouping definition the UE is configured to utilize to define the UE group 506. While described in some instances as being proximate to one another to define a UE group 506, the techniques of this disclosure are not so limited, and a person of ordinary skill in the art will understand that the UEs of the UE group 506 may not necessarily be co-located to form the UE group 506. In an example, a first UE belonging to User A may correspond to a vehicle traveling on a freeway or to another UE located away from a second UE belonging to User A and/or User B, with the first UE and the second UE nevertheless being suitable for defining a UE group 506 in various instances.

In addition, the UE 510 may include a virtual UE representing a combination of one or more other physical UE devices in a UE group 506. Assuming a configurable cooperation between UEs within the UE group 506, the network device 504 may potentially leverage the radio communication link 520 established with UE 510 (e.g., a virtual UE) to then communicate with each of the other downstream UEs in the UE group 506.

In some examples, the network device 504 may communicate with a virtual UE. In an example, a virtual UE may represent a formation of UEs in a particular set of UEs. That is, multiple scheduled entities 106 may form a virtual UE to essentially disguise the multiple scheduled entities 106 into appearing as a single scheduled entity 106 from the perspective of another device interfacing with the virtual UE. The scheduled entities 106 may do so for purposes of resource sharing. As such, the scheduled entities 106 may form a virtual UE. The virtual UE may, in some examples, be the same as a UE group. In another example, the virtual UE may include a multiple of seamlessly and/or integrally connected UEs, where at least one of the connected UEs of the virtual UE is part of a particular UE group 506. In some examples, the scheduled entities 106 may do so by combining and/or sharing resources in a communal type manner. In another example, the network device 504 may communicate with one or multiple UEs within a logical grouping of UEs (e.g., a UE group 506). In such examples, the logical grouping of UEs may include one or more UEs, including one or more virtual UEs in some instances, that the upstream network device 504 may interface with to communicate with one or more of the UEs 106 (e.g., UE 510) and/or virtual UEs (e.g., UE 512, UE 514, and/or UE 516, etc.) of the UE group 506.

In some examples, the network device 504 may communicate wirelessly with the UE 510 via the radio link 520 that has been established between the UE 510 and the network device 504. In some examples, however, a UE 510 may generally require more power to transmit data over radio link 520 compared to an amount of power consumed transmit that same data to another UE (e.g., UE 512). That is, the UE 510 may consume less of its communication resources communicating with another UE 512 of the UE group 506 via a communication link 524 between the UEs, for example. This is because the UE 510 may utilize a close-range data transfer technique when communicating with the other UE 512 that may only be available between UEs (e.g., of the group 506). In such examples, the UE 510 may consume less of its own communication resources to communicate with another UE within the UE group 506 (e.g., UE 512, UE 516, etc.) compared to when communicating directly with a network device 504 via radio link 520. This is because some UEs within the UE group 506 may be better suited for communicating with a network device 504 at any given point in time. In an example, a network device 504 may be located far away from one or more of the UEs within the UE group 506. Thus, in some instances, one or more particular UEs within a UE group 506 may have better communication resources at any given point in time relative to other UEs within the UE group 506. This may include better access to power resources (e.g., plugged into an outlet, etc.), more power capacity at the time, different antennas, better signal-to-noise (SNR) capabilities, better processing power, and so forth.

In an illustrative example, a first UE (e.g., a virtual UE) may be the mobile communications device 510. A second UE may be the computing device 512. The first UE 510 and the second UE 512 may then, in various instances, communicate with one another over a wireless and/or wired communication link 524. The first UE 510 and the second UE 512 may execute a communication exchange do so with or without the assistance of a radio access network (RAN) implemented via network device(s) 504. In another example, the first UE may be a first wearable device 514 worn by a first User A, and the second UE may be a second wearable device 518 worn by a second User B. In such examples, the first UE and the second UE may communicate with one another over a wireless and/or wired communication link. In an example, the first wearable device 514 and the second wearable device 518 may communicate with one another using any suitable communication link (e.g., a wireless link) established between such devices.

In another example, the first wearable device 514 and the second wearable device 518 may communicate with one another using a communication link established with the computing device 512, for example. Accordingly, the computing device 512 may serve as an intermediary between the wearable devices. In addition, or alternatively, the computing device 512 may serve as an intermediary between the at least one network device(s) 504 and the wearable devices 514 and 518. That is, the wearable devices 514 and 518 may leverage computing device 512 and in some instances, network device(s) 504 (e.g., via radio link 522) to effectively communicate with one another. Thus, the wearable devices 514 and 518 might communicate with one another, as well as with potentially any number of additional UEs, while relying on power, memory, and processing resources of the computing device 514 or of the network device 504. Thus, the wearable devices may conserve such communication resources, even when not plugged directly into any external power source at the time. The wearable devices sharing communication resources in this way may, thus, variously resemble one or more virtual UEs. Each virtual UE can emerge from a harmonious balance struck between at least two physical UEs in a UE group 506. With virtual UEs, physical resources may be combined and thus consumed in a way that benefits the virtual UEs and the UE group 506 as a collective or partnership of otherwise independent and individual UE devices in the UE group 506.

A first UE and a second UE (e.g., in a UE group 506) may, in some instances, communicate with one another over a wireless and/or wired communication link, either with or without a radio access network (RAN) assisting in the handling of any such communication exchange between UEs. Thus, while certain types of connections are discussed herein for exemplary purposes, those skilled in the art will appreciate that a variety of connections (e.g., communication links) may exist between certain UEs at any given point in time depending on availability of such connections between a set of UEs attempting to connect, as well as with the UEs and the network devices 504. In some examples, a person of ordinary skill in the art may refer to such UEs as representing an Internet of Things (IoT) that may advantageously leverage radio links established with one or more network devices 504, even if only temporarily at times, in order to facilitate a communicative exchange between a set of variously interconnected UEs. In this way, the communication network 500 may represent a dynamic network having an adaptive quality. In an example, this adaptive quality allows the communication network 500 to reallocate or divert network resources between UEs as changes in the network occur that disrupt what may otherwise be a harmony of mathematical precision.

### Utilizing Resources of Relay Device for Enhanced Data Transmission

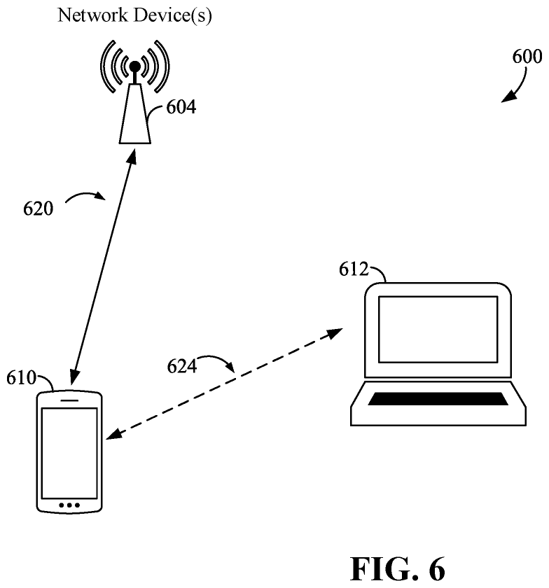

FIG. 6 provides a schematic illustration of a communication network 600 including a first scheduled entity 610 (e.g., a first user equipment (UE)) in active communication with at least one network device 604 (e.g., a scheduling entity 108), and a second scheduled entity 612 (e.g., a second UE) according to some examples. The second UE 612 may be in a sleep state or may otherwise not be in communication with the network device 604 at the particular time. As before, the communication network 600 may represent an example of the communication network 500 described, for example, with reference to FIG. 5.

In some examples, the first scheduled entity 610 may communicate with a first network device 604, such as a base station (BS) or other scheduling entity 108. While network device 604 is shown as a base station (BS), in various examples, the techniques of this disclosure are not so limited. In some examples, the network device 604 may include another UE that coordinates a scheduling of data exchanged between various devices of communication network 600.

In some examples, the first UE 610 may be in communication with the network device 604 using a first radio link 620 (e.g., a wireless link). The network device may utilize the first radio link 620 between the network device 604 and the first UE 610 to transmit control information (e.g., downlink control information (DCI)), data channels (e.g., physical downlink shared channels (PDSCH)), and/or reference signals (RSs), to the first UE 610, in various examples. The network device may further utilize the first radio link 620 to request channel state information (CSI) from the first UE 610, and to receive CSI reports from the first UE 610.

The first UE 610 and the second UE 612 may be part of a UE group or may lend themselves to being formed (e.g., conjoined) as a UE group, such as the UE group 506 of FIG. 5. The first UE 610 and the second UE 612 may do so for purposes of providing enhanced wireless communication with network elements (e.g., one or more network devices 604) of the communication network 600. The second UE 612, however, may not be engaged to help the first UE 610 with communicating data within the communication network 600.

For multiple UEs, an upstream scheduling entity 108 (e.g., network device 604), in general, may not assume any information exchange between UEs 106. In an example, an upstream scheduling entity 108 may communicate with each UE 106 in a set of UEs separately as though effectively communicating with different users for each UE 106 in the set of UEs. That is, an upstream scheduling entity 108 may do so regardless of whether such UEs correspond to a single user operating the multiple UEs 106 and/or a single UE group. In other words, the scheduling entity 108 may effectively treat multiple UEs as multiple users for general communication purposes.

In some examples, the first UE 610 may be a power-sensitive device, such as a mobile phone. The second UE 612 may be a nearby power-insensitive device that may be near the first UE 610 or in a same UE group as the first UE 610, but the second UE 612 may be sleeping at the time. In any case, the second UE 612 may be considered power-insensitive because it may have better power resources, such as a longer lasting battery, better power savings applications, or may be connected to an external power source, such as by having access to wired power via an electrical wall outlet.

In addition, the second UE 612 may be a computing device that at any given point in time may be operating in a sleep state (e.g., an idling state). In an illustrative example, a user (e.g., User A) may have placed the second UE 612 into the sleep state, for example, as the user left the vicinity of the second UE 612. The second UE 612 and the first UE 610 may nevertheless still have formed a connection with one another via communication link 624 (e.g., a second radio link) that may endure regardless of whether one of the UEs is no longer in communication with the network device(s) 604 (e.g., due to one UE being asleep, etc.). That is, when operating in certain operating modes (e.g., a sleep state, a low-power mode, a discontinuous reception (DRX) mode, etc.), the second UE 612 may not have a radio link established with the network device(s) 604 and/or may not be monitoring a radio link for any downlink (DL) transmissions from the network device(s) 604 at any given point in time.

In such examples, the second UE 612 may not be engaged to assist the first UE 610 with receiving DL data from the network device(s) 604. That is, the second UE 612 may be in a sleep mode or otherwise may not be in communication with the network device(s) 604 at a given point in time, while the first UE 610 is communicating with the network device(s) 604 via the first radio link 620. This may result in an unbalanced use of UEs.

In such examples, when the network device 604 is communicating with the first UE 610 via the first radio link 620, the network device 604 and the first UE 610 may be underutilizing, disregarding, and/or otherwise wasting potentially useful communication resources of another UE 106 in a UE group (e.g., the second UE 612). In such examples, the second UE 612 could instead be utilized to receive DL data via a radio link (not explicitly shown in FIG. 6) between the second UE 612 and the network device(s) 604 regardless of whether the second UE 612 is in a low-power state. The second UE 612 could then relay that DL data to the first UE 610 in conjunction with the network device(s) 604 transmitting DL data to the first UE 610 as well. In this way, the network device(s) 604 may provide the first UE 610 with DL data in a data flow that flows to the first UE 610 over a wider and more robust data stream where resources of the second UE 612 are utilized for communicating relay data to the first UE 610 via communication link 624. In such examples, communication link 624 may include a second radio link (e.g., a sidelink).

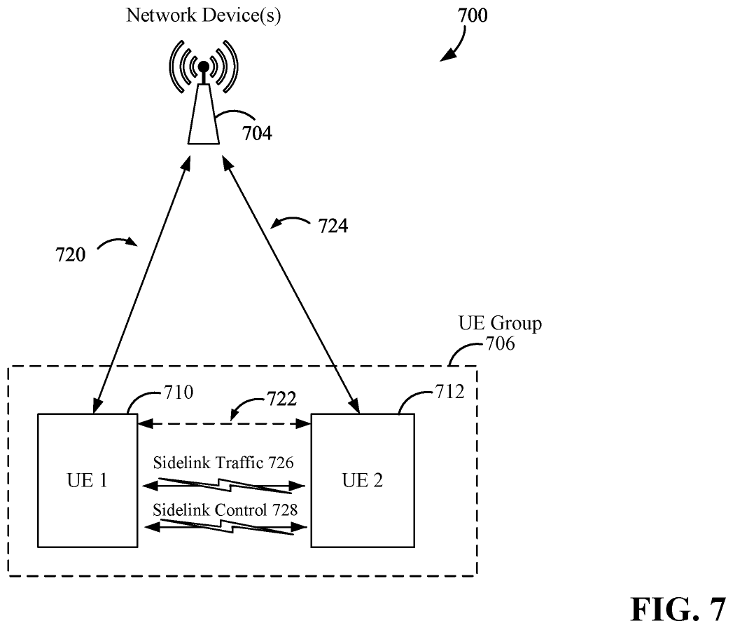

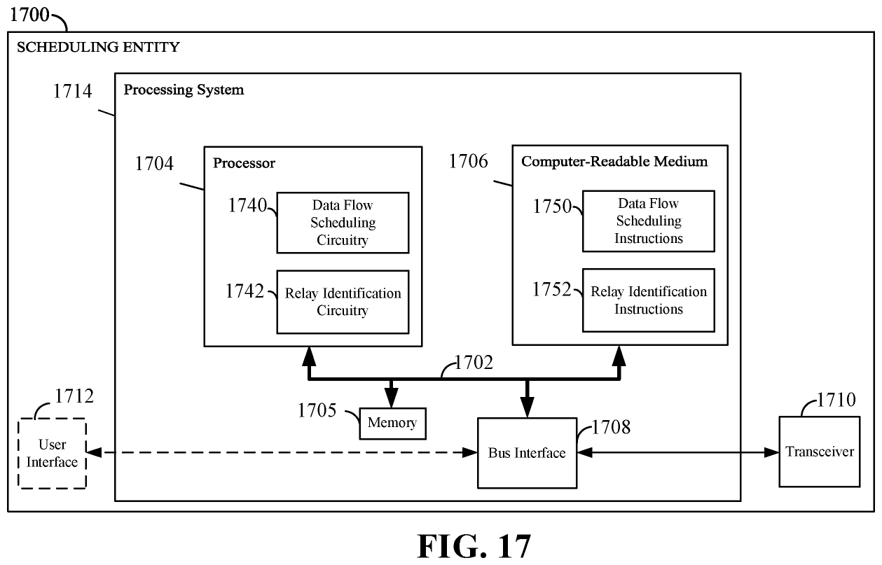

FIG. 7 provides a schematic illustration of a communication network 700 including a first user equipment (UE) 710 and a second UE 712 in a UE group 706 according to some examples. As before, the communication network 700 may represent an example of the communication network 500 described, for example, with reference to FIG. 5. In various examples, the upstream network device(s) 704 corresponds to one or more scheduling entities 108, described herein, for example, with reference to FIGS. 1, 2, 3, and/or FIG. 17.

In an illustrative example, the first UE 710 may communicate with the network device(s) 704 via a first radio link 720. In addition, the second UE 712 may communicate with the network device(s) 704 via a second radio link 724. In such examples, the first UE 710 and/or the second UE 712 may report to the network device(s) 704 the UEs' capability of deploying multiple processing units to communicate data between one or more UEs and the network device(s) 704. That is, the first UE 710 and/or the second UE 712 may report to network device(s) 704 their capability of deploying multiple processing units that are spread across multiple UEs 106 of a UE group 706 in order to receive and/or transmit data between a particular UE 106 (e.g., the first UE 710 or the second UE 712) and the network device(s) 704. In an example, the first and second UEs 710 and 712 may do so via a data flow (e.g., a data stream) that leverages the first radio link 720 and the second radio link 724 for the data flow of downlink (DL) data. In addition, the first and second UEs 710 and 712 may leverage a third radio link, including sidelink traffic 726 and sidelink control 728 to complete the flow of DL data to one or the other UE 106.

In some examples, a UE 106 of the UE group 706 may report to the network device(s) 704 multiple UEs of the UE group 706 belong to a same user. In an example, the UE 106 may notify the network device 704 of one or more UEs corresponding to User A, one or more UEs corresponding to User B, and/or one or more UEs corresponding to no user or alternatively to multiple users (e.g., User A and User B, etc.). In an example, the UE 106 may do so based on registration of a device to various users or multiple users, authentication credentials shared across devices, geolocation patterns indicating a particular user of multiple UEs 106. In an example, User A may carry the first UE 710 in their pocket and wear the second UE 712 as a wearable device (e.g., watch, VR goggles, etc.) for significant portions of the day.

In such examples, the first UE 710 and/or the second UE 712 may indicate that the UEs form a UE group 706. As such, the network device(s) 704 may advantageously leverage communication resources of the second UE 712 while communicating DL data to the first UE 710 in a data flow that utilizes multiple radio links (e.g., the first radio link 720 and the second radio link 724) spread across multiple UEs. In this way, the network device(s) 704 may increase the probability that the data the network device(s) 704 are communicating to the first UE 710 arrive successfully at the first UE 710 in the data flow (e.g., either from network device(s) 704 via a relay UE (e.g., the second UE 712), from another relay UE (not shown), or direct via the first radio link 720). In any case, users may use a second UE 712 to help a first UE 710 receive signals from and/or transmit signals to one or more network device(s) 704.

In some examples, scheduled entities, such as a first UE 710 (“UE 1”) and a second UE 712 (“UE 2”), may utilize sidelink (SL) signals for direct device-to-device (D2D) communication. Sidelink (SL) signals may include sidelink traffic 726 and sidelink control 728. Sidelink control 728 may, in various instances, include sidelink control information (SCI). In an example, a physical sidelink control channel (PSCCH) may carry the SCI over a communication link 722 (e.g., a third radio link) between the first UE 710 and the second UE 712.

In some examples, the sidelink control 728 may include a request signal, such as a request-to-send (RTS), a source transmit signal (STS), and/or a direction selection signal (DSS). The request signal may provide for a scheduled entity 106 to request a duration of time to keep a sidelink channel available for a sidelink signal. Sidelink control information may further include a response signal, such as a clear-to-send (CTS) and/or a destination receive signal (DRS). The response signal may provide for the scheduled entity 106 to indicate the availability of the sidelink channel, e.g., for a requested duration of time. An exchange of request and response signals (e.g., handshake) may enable different scheduled entities performing sidelink communications to negotiate the availability of the sidelink channel prior to communication of the sidelink traffic 726 (e.g., sidelink data exchanged from one UE to another UE via a physical sidelink shared channel (PSSCH) over a communication link 722). The UEs may utilize such radio links to facilitate an exchange of data between UEs. In some examples, the first UE 710 may utilize a PC5 signaling protocol procedure to initiate the sidelink connection with the second UE 712.

In some examples, the UEs within a UE group 706 may communicate with one another using additional modes of communication, such as another communication link 722 (optional) that can be any kind of direct and/or indirect connection. In an example, the first and second UEs 710 and 712 may utilize communication links that are implemented via one or more of a local area network (LAN), a personal area network (PAN), a Bluetooth connection (BT), over a Wi-Fi network, and so forth. While described in some examples herein as utilizing a radio link between UEs to transmit sidelink traffic 726 and/or sidelink control 728 when communicating relay data from network device(s) 704, the techniques of this disclosure are not so limited. A person of ordinary skill in the art will understand that relay data may, in some instances, be additionally or alternatively communicated via another communication link 722.

While network device 704 is shown as a base station (BS) in various examples, the techniques of this disclosure are not so limited. In some examples, the network device 704 may include another UE, such that the communication network (e.g., a mesh network) involves an exchange of data between the first and second UEs 710 and 712, where the UEs 710 and 712 communicate with a third, upstream UE (not shown) over the first radio link 720 and/or the second radio link 724. In such examples, the UEs 710 and 712 may continue communicating with one another over the third radio link 722 utilizing data flows between the UEs 710 and 712. In an example, a first data flow may include multiple data flows that utilize a primary serving cell and multiple secondary serving cells to exchange an array of PSSCHs between devices carried over the multitude of serving cells from the first UE 710 to the second UE 712.

### Communicating Relay Data to a Destination Device

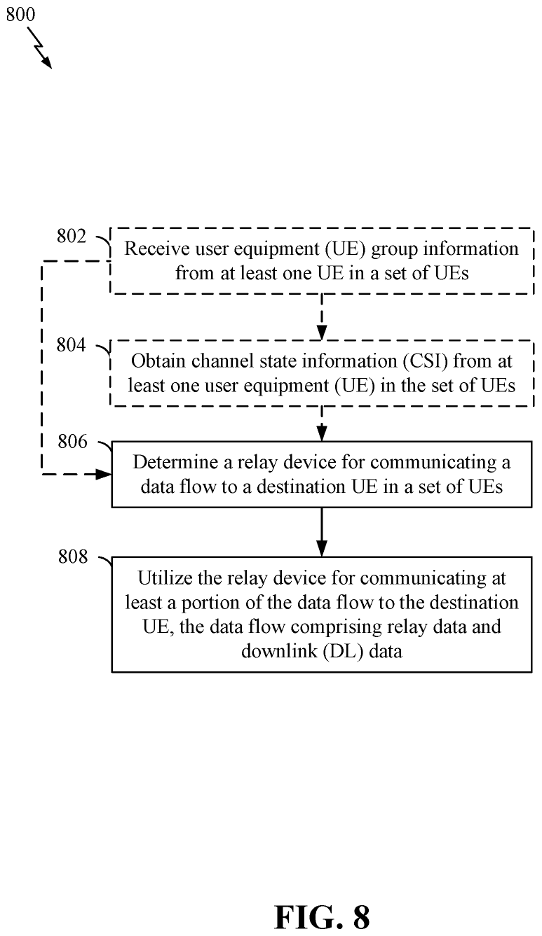

FIG. 8 is a flow chart illustrating an exemplary process 800 for utilizing a relay device (e.g., a relay UE) for communicating data between a scheduling entity (e.g., a base station (BS)) and a scheduled entity (e.g., a user equipment (UE)) in accordance with some aspects of the present disclosure. As described herein, a particular implementation may omit some or all features, and may not require some illustrated features to implement all embodiments. In some examples, the process 800 may be carried out by the scheduling entity 1700 illustrated in FIG. 17. In some examples, any suitable apparatus or means for carrying out the functions or algorithm described herein may carry out the process 800.

At block 802, a scheduling entity 108 (e.g., a scheduling entity 1700) may receive UE group information from at least one UE 106 in a set of UEs. In an example, network device 704 may receive UE group information from UE 710 or from UE 712. In such examples, the scheduling entity 108 may utilize the UE group information to determine whether a UE (e.g., UE 712) in the UE group 706 may be suitable for serving as a relay device for relaying data to another UE (e.g., UE 710) representing the destination device.

In some examples, the UE group information may indicate that the UEs form a UE group 706. The UE group information may further indicate whether a set of UEs within UE group 706 belong to one user or multiple users. In an example, the UE group information may indicate that the first UE 710 and the second UE 712 correspond to User A. In another example, the UE group information may indicate that the first UE 710 and the second UE 712 correspond to different users. In some examples, the first UE 710 may indicate all devices within the UE group 706 that belong to User A, and the second UE 712 may indicate all devices within the UE group 706 that belong to User B. In such examples, the UE group information may indicate that all UEs of the UE group 706 correspond to one user (e.g., User A).

In another example, the UE group information may indicate that the UEs are connected via a particular network connection, such as a local area network (LAN) connection or a personal area network (PAN) connection, in addition to or alternatively to being connected via a radio link (e.g., a sidelink). In yet another example, the UE group information may include geolocation information for the network device(s) 704 to use, for example, when determining a set of UEs for a particular UE group. The network device(s) 704 may receive the UE group information, and determine which UEs 106 belong to a UE group 706. In another example, the UE group information may explicitly indicate which UEs 106 belong to a UE group 706.

In some examples, a network device 704 may receive the UE group information from another network device 704, such as from a network data server that maintains UE group information for various UEs 106 of the communication network 700, transmits the UE group information to the network device 704 or the UEs of the UE group 706, and/or updates the UE group information with data defining the UE group 706, such as channel state information (CSI) historical data for providing details regarding relay devices used historically within a particular UE group 706, and so forth. While the UE group information is described as including various pieces of information regarding the UE group 706, the techniques of this disclosure are not so limited. A person of ordinary skill in the art will understand that UE group information may include other information useful in defining a UE group 706 for utilizing a UE in the UE group 706 for relay purposes.

In some examples, the UE group information may identify specific UEs that the UE group designates as suitable for operating within a relay configuration context. That is, a UE within UE group 706 may indicate to a network device 704 in the UE group information that a particular UE (e.g., the first UE 710 or the second UE 712 is a suitable relay device. In such examples, the UE group information may indicate that the network device 704 is to utilize the indicated UE as the relay device regardless of whether the network device 704 has or could identify a better relay device in the UE group 706, such as based on channel quality information (CQI) the network device 704 determines between a set of UEs in a UE group 706. In some instances, the network device 704 may utilize the UE group information to identify an initial UE in the UE group 706 to serve as a relay device in a relay configuration. In such examples, the network device 704 may determine a more suitable UE in the UE group 706 that the network device 704 may leverage as a relay device.

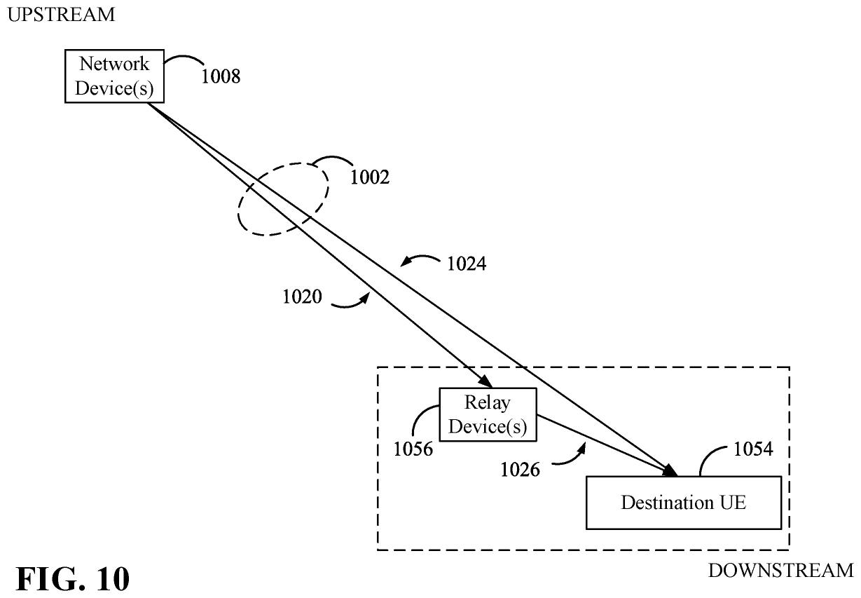

In some examples, the network device 704 may determine a new (e.g., subsequent) relay device based on CQI between UEs in the UE group 706 while the network device 704 is transmitting relay data using another UE (e.g., the initial UE of the UE group information). As such, the network device 704 may transition from transmitting relay data to the initial UE to instead or additionally transmit the relay data through the newly identified relay device to the destination UE. In any case, the network device 704 may transmit a primary set of data items, such as downlink (DL) data via a physical downlink shared channel (PDSCH). As such, the network device 704 may transmit the data flow to the destination UE before, during, and following a transition between relay devices without necessarily interrupting the data flow (e.g., the data flow illustrated in FIG. 10 as data flow 1002) as the network device 704 actively diverts and manages the data flow to leverage different relay devices within a UE group 706.

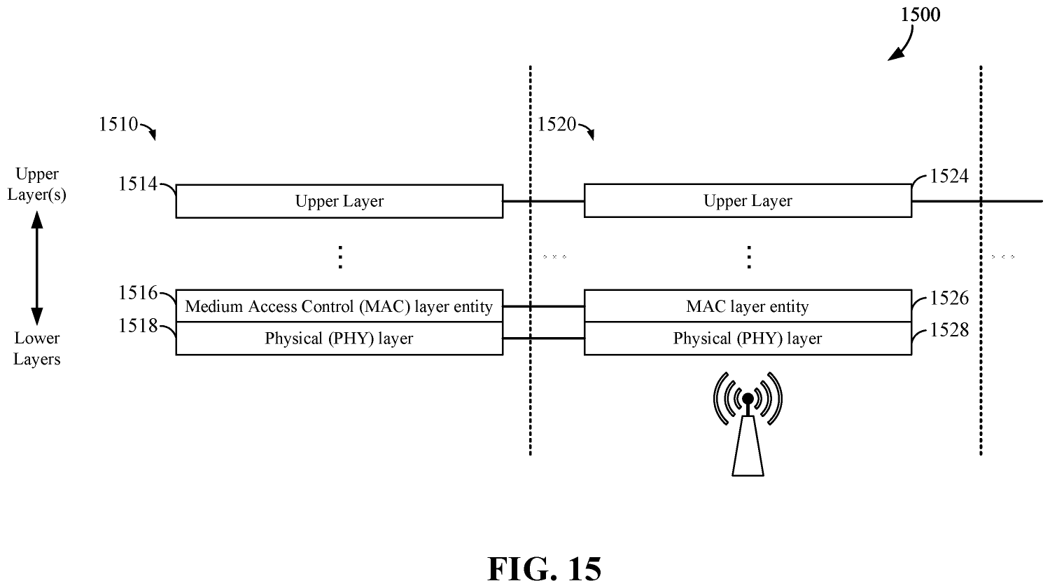

In some examples, the radio link 720 and/or the radio link 724 may include multiple layers of a protocol stack, such as for a user plane and/or a control plane. In such examples, the UE(s) and network device 704 may implement individual layers for various communication purposes. In such examples, the UEs 106 may transmit UE group information to the network device 704 using any layer of a protocol stack (e.g., lower layer or higher layer) of the protocol stack. In an example, the first UE 710 and/or the second UE 712 may transmit the UE group information to the network device 704 over the first radio link 720 and/or the second radio link 724 via an upper layer (e.g., an adaptation protocol layer, an application layer, etc.). An example of such layers is illustrated and described, for example, with reference to FIG. 15. In such examples, the upper layer 1514 may be associated with the destination UE 106, and the upper layer 1524 may be associated with the network device 704. In an illustrative and non-limiting example, the network device 704 and a UE of the UE group 706 may communicate UE group information over a radio link. In an example, the radio link can include the radio link 720 associated with UE 710. In another example, the radio link can include the radio link 724 associated with UE 724. In any case, a UE in UE group 706 and the network device 704 may communicate information over a given radio link via the corresponding layers (e.g., upper layers 1514/1524 of FIG. 15, and/or MAC layer entity 1516/1526 of FIG. 15, etc.).

In some examples, block 802 may be optional and as such, may not occur in various implementations of the process 800. In an example, certain UEs 106 within a UE group 706 may correspond to different users (e.g., User A, User B, etc.). In an illustrative example, the first UE 710 may belong to and/or may be registered to User A. The second UE 712 may belong to and/or may be registered to User B. In such examples, the network device(s) 704 may not utilize UE group information (e.g., as may be received from the UEs 106 of a UE group 706) to determine a relay device of the potential relay UEs 106 in the UE group 706. In an example, the network device(s) 704 may request channel state reports from the UEs 106 of the UE group 706 for such purposes. That is, a first UE within a UE group 706 may elect or volunteer a second UE to serve as a relay device for relaying activities when the first UE and the second UE are controlled by the same user. This is because one user may not necessarily be willing to consent to having its UE(s)' communication resources to be commandeered for relaying purposes to support another user's UE-to-network data communication activities.

At block 804, the scheduling entity 108 (e.g., network device 704, etc.) may obtain channel state information (CSI) from at least one UE 106 in a set of UEs. In an example, a network device 704 may obtain one or more CSI reports from UE 710 and/or UE 712 of the UE group 706. Block 804 is also optional, such as when block 802 is not omitted from a particular implementation of process 800.

In an example, the network device 704 may request a CSI report from one or more UEs in a UE group (e.g., UE group 706). In such examples, the network device 704 may transmit CSI report configuration information to the one or more UEs in the UE group. The CSI report configuration information may provide a CSI report format for the one or more UEs to follow when obtaining and reporting CSI relative to a particular channel. In some examples, the CSI report format may include a request for a UE group report. The UE group report may convey CSI regarding radio links established between UEs and between the UEs and the network device 704.

In some examples, a UE 710 and/or UE 712 may determine a set of channel state coefficients relative to a radio link between the first UE 710 and the second UE 712. In an example, the first UE 710 may transmit one or more reference signals to the second UE 712 during a measurement period. The second UE 712 may measure the one or more reference signals to estimate the channel between the UEs. In some examples, the UE(s) may determine, from such measurements, the channel quality information (CQI) regarding the channel between the UEs. In an example, the first UE 710 may determine a signal-to-noise ratio (SNR) relative to a channel established between the two UEs as representative of the CQI. In any case, the first UE 710 and/or the second UE 712 may thus prepare a CSI report to include the CQI (e.g., the SNR) relative to the radio link between the UEs.

The first UE 710 and/or the second UE 712 may further measure the channel between the UE(s) and the network device 704. In an example, the network device 704 may transmit channel state information reference signals (CSI-RSs) to the first UE 710. In such examples, the UEs may perform additional channel state measurements as it relates to the first radio link 720 and/or the second radio link 724. In an illustrative example, the UEs 106 may receive a set of reference signals from the network device(s) 704. The UEs 106 of the UE group 706 may determine the set of channel state coefficients based on a measurement of the reference signals. These channel state coefficients may include CQI. In some examples, the UEs 106 may determine a precoding matrix indicator (PMI) to transmit to the network device 704 as part of the channel state report. In some instances, the UEs 106 may include in the channel state report (e.g., a group channel state report) a set of channel coefficients that the network device 704 may utilize for determining a PMI for a downlink (DL) precoding matrix.

In some examples, the network device(s) 704 may perform similar measurements based on reference signals received from the downstream devices (e.g., from the first UE 710 and/or from the second UE 712). The network device(s) may do so at predetermined intervals, e.g., to determine a precoding matrix for precoding signals sent via various antenna ports. In such instances, the network device(s) 704 may determine whether a UE may be suitable to serve as a relay device for handling a data flow from the network device(s) 704 to a destination UE. In any case, the UEs may transmit a CSI report to the network device 704. That is, a UE 106 (e.g., a destination UE 712/710) may generate a first level of channel state information relative to the channels between potential relay UE(s) and a destination UE of the UE group 706. In addition, the UE 106 may generate a second level of channel state information that includes additional information, such as precoding information (e.g., PMI).

In such examples, the first level of CSI may include a lesser degree of information relative to the second level of CSI. This is because the upstream scheduling entity 704 may use the first CSI report to determine whether a potential relay path has a channel quality that satisfies a radio link quality threshold, such that a particular UE may serve as a relay UE for relaying data to the destination UE. However, the upstream scheduling entity 704 may use the second CSI to adjust transmission parameters for transmitting signals (e.g., determine a DL precoder matrix for precoding signals) to a scheduled entity 106. In any case, the UE 106 may include the first set of channel coefficients and the second set of channel coefficients in a single CSI report. In another example, a UE 106 may transmit this information separately in individual CSI reports. This may depend on the CSI format included in the CSI report configuration.

In some examples, a UE 106 (e.g., UE 710) may generate one or more channel state reports (e.g., a group channel state report, an individual/dedicated channel state report, etc.) to transmit to the network device(s) 704. As such, the UE 106 may determine a first set of information to characterize the channel between the UEs in the UE group 706 and may determine a second set of channel state coefficients to characterize the channel between the UE(s) and the network device 704. In some examples, the UEs may generate the channel state report to include only a comparison value for the various radio links. In this way, the UEs may reduce their overhead when reporting the channel state of the radio link between the UEs.

In an example, the second UE 712 may determine a first CQI value relative to a communication link 722 (e.g., a sidelink or third radio link) between the first UE 710 and the second UE 712. The second UE 712 may further determine a second CQI value relative to the second radio link 724 between the network device(s) 724 and the second UE 712. The second UE 712 may generate a channel state report to include the second CQI value and a comparison value representing a difference between the first CQI value and the second CQI value. In addition, the network device(s) 704 may receive a channel state report from the first UE 710 over the first radio link 720 characterizing the relevant channels between the UEs 710 and 712, and between the network device(s) 704. In this way, the network device(s) 704 may determine whether a particular set of UEs (e.g., the first UE(s) 710) may serve as a relay device (which may be referred to as a relay UE) for relaying data (e.g., sidelink relay data) to the second UE 712 (which may be referred to as a destination UE) in a relay configuration.

In an illustrative example, the group UE report may indicate (e.g., with a CQI comparison value) that the communication link 722 between the destination UE 712 and a potential relay UE 710 has a relatively high SNR compared to an SNR measured for the second radio link 724 between the destination UE 712 and the network device 704. In addition, the group UE report may indicate that the first radio link 720 between the potential relay device 710 and the network device 704, and the communication link 722 (which may be referred to as a relay link) between the UEs 710/712 has a combined SNR that is superior to the SNR measured for the second radio link 724. In such instances, the network device(s) 704 may determine to utilize the first UE 710 as a relay device in a relay configuration based at least in part on the superior CQI obtained for the relay communication path through the first UE 710 (e.g., via the first radio link 720 and the relay link 722) compared to that of the CQI obtained for the second radio link 724.

In some examples, the upstream scheduling entity 108 (e.g., the network device(s) 704) may receive one or more CSI reports over a given CSI reporting period (e.g., one UE group report per slot, one UE group report per a series of multiple slots, etc.). In an example, a downstream UE in the UE group 706 may transmit a CSI report as a UE group report that conveys CSI regarding multiple radio links. In an example, the multiple radio links may include those radio links established between a set of UEs 106 (e.g., between the first UE 710 and the second UE 712) and between one or more UE(s) 106 and the network device 704 (e.g., the first radio link 720 and/or the second radio link 724).

In an illustrative example, a UE group report may include CSI relative to measurements of channel state information reference signals (CSI-RSs) performed relative to the first radio link 720, the second radio link 724, or both. In an example, the first UE 710 may obtain a set of channel state coefficients upon measuring one or more CSI-RSs transmitted via the first radio link 720. In some examples, the first UE 710 may convey the set of channel state coefficients to network device(s) 704 and/or to the second UE 712. In such examples, the second UE 712 may receive the set of channel state coefficients from the first UE 710 relative to measurements performed on the first radio link 720. In addition, or alternatively, the second UE 712 may receive a set of channel state coefficients from the first UE 710 including measurements the first UE 710 performs on the communication link 722 (e.g., a sidelink or third radio link) between the first UE 710 and the second 712. The second UE 712 may combine such information in a UE group report and may transmit the UE group report to the network device 704.

While described in various CSI formatting configurations throughout this disclosure, the techniques of this disclosure are not so limited. A person of ordinary skill in the art will understand that the network device 704 may utilize additional or alternative CSI formatting configurations to determine the relay potential within various UE groups 706 (e.g., between various UEs 106). In an example, the first UE 710 and the second UE 712 may transmit to a network device 704 PMI information as between the first UE 710 and the second UE 712, similar to PMI the UEs may include in a CSI report applicable to a radio link established with an upstream scheduling entity 108 for the scheduling entity 108 to use, for example, when updating a downlink (DL) precoder.

The network device 704 may receive the UE group report through lower layer or higher layer signaling. In an example, the network device 704 may receive the CSI report (e.g., a UE group report) via one or more lower layers of a communication protocol stack, such as via a medium access control (MAC) layer entity or a physical (PHY) layer. In another example, the network device 704 may receive the CSI report via an upper layer, such as an upper layer relative to the MAC layer entity and/or the PHY layer.

In some examples, the network device 704 may determine a relationship between the device IDs of the UEs 106 of UE group 706 and the physical UEs within the UE group 706. In an example, the network device 704 may determine a mapping for a relationship between device IDs and physical devices relative to UE group 706. The network device 704 may utilize this mapping to determine which UE(s) to transmit a request to requesting a channel state report (e.g., a UE group report, a comprehensive report) pertaining to multiple UEs in the UE group 706. In an example, the upstream scheduling entity 704 (e.g., a gNB, road side unit (RSU), etc.) obtains information relative to the UE device ID for the UE 710 while transmitting data to the destination UE 712.

In some examples, the upstream scheduling entity 704 may identify a relationship between the first UE 710 and the second UE 712 indicative of the first UE 710 as being a candidate relay device for the upstream scheduling entity 704 to leverage when communicating with the second UE 712. In such examples, the upstream scheduling entity 704 may request a CSI report from first UE 710. The request may indicate a CSI format for the first UE 710 to include, as part of the CSI report, CSI relative to a communication link 722 (e.g., as a potential relay link) between the destination UE 712 and the relay UE 710. In some examples, the request may serve as an implicit indication for the relay UE 710 and/or the destination UE 712, for example, to initiate monitoring a relay set of resources relative to the radio link between the UEs 106 in UE group 706. In such examples, the destination UE 712 may continue monitoring a primary set of resources relative to the second radio link 724 for a first portion of the data flow to include downlink (DL) data. Based on the implicit indication of the CSI request in such examples, the destination UE 712 may additionally monitor for a second portion of the data flow to include relay data related to the DL data (e.g., a duplicate of the DL data, a complementary data set for combining with the DL data to form together a full data set, etc.).

In some examples, a potential relay UE 710 may obtain and report the CSI the potential relay UE 710 measures between certain UEs within the UE group 706. In such examples, the potential relay UE 710 may report the CSI relative to one or more UEs within the UE group 706. In some examples, the potential relay UE 710 may do so in addition to reporting CSI (e.g., a set of channel coefficients, a set of linear combination coefficients, etc.). In some examples, the potential relay UE 710 may generate a CSI report to include CSI the UE(s) measure between UEs in the UE group 706 (e.g., CSI between a relay UE 710 and destination UE 712). In another example, the potential relay UE 710 may generate a CSI report that includes additional CQI values regarding the relay link 722 between UEs.

At block 806, the upstream scheduling entity 108 (e.g., the at least one network device 704) may determine a relay device for communicating a data flow to a downstream scheduled entity 106 in a set of scheduled entities 106 (e.g., a UE group 706). In an illustrative example, the network device 704 may transmit or be in the process of transmitting data to a second UE 712 (e.g., a destination UE 712). In such examples, the network device 704 may determine a first UE 710 may serve as a relay UE 710 for relaying the data to the destination UE 712.

In such examples, the upstream scheduling entity 108 may determine the destination UE 712 may receive a downlink (DL) data flow (e.g., a data flow or stream) from the upstream scheduling entity 108 via multiple communication links (e.g., multiple radio links). In some examples, the upstream scheduling entity 108 may determine a presence of or an opportunity to leverage a relay UE 710 for transmitting relay data to the destination UE 712 as part of a robust data flow. In an example, the upstream scheduling entity 108 may use the relay UE 710 to better ensure certain data (e.g., higher priority data) in the data flow reaches the destination UE 712 (e.g., as a duplicate instance of the data or as a complementary instance of the data) with a higher likelihood of successfully receiving the data.

At block 808, the upstream scheduling entity 108 (e.g., at least one network device 704) may utilize the relay UE 710 for communicating at least a portion of the data flow to the destination UE 712 (e.g., the second UE 712). In such examples, the data flow may include relay data and/or downlink (DL) data. In an example, the upstream scheduling entity 108 (e.g., at least one network device 704) may transmit a physical downlink control channel (PDCCH) over the second radio link 724 with the second UE 712 (e.g., the destination UE 712) in a UE group (e.g., UE group 706).

Referring now to FIG. 10, a data flow 1002 may flow from an upstream network device 1008 to a destination UE 1054 over a first radio link 1024, a second radio link 1020, and a third radio link 1026. That relay UE(s) 1056 may receive a portion of the data flow (e.g., a duplicate portion, a split portion, etc.) from the network device(s) 1008. This portion of the data flow may include relay data for the destination UE 1054 that the network device 1008 sends to the destination UE 1054 via the relay UE 1056.

In some examples, the first portion of a data flow 1002 may include one or more physical downlink shared channels (PDSCHs). The PDSCHs may convey an encoded set of data packets the network device 1008 transmits to the destination UE 1054 (e.g., UE 712) for the destination UE 1054 to decode and reassemble, for example. In some instances, the second portion of the data flow 1002 may include the same PDSCHs conveying a duplicate of the encoded set of data packets. That is, the relay data may be a duplicate of the downlink (DL) data flow sent to the destination UE 1054. In this way, the destination UE 1054 may monitor for the data to arrive as DL data or as relay data, such that the destination UE 1054 upon receiving the data flow 1002 may proceed with one or more portions of the data flow 1002 in order to successfully receive the full data flow.

In another example, the second portion of the data flow 1002 may include a complementary set of data packets to complement or supplement those data packets of the first portion of the data flow 1002. In such examples, the destination UE 1054 may receive an indication that to successfully receive the data flow 1002, the destination UE 1054 may combine a first portion of the data flow 1002 with a second portion of the data flow 1002, with the portions arriving at the destination UE 1054 over multiple radio links (e.g., the first radio link 1024 and the second radio link 1020). In any case, the data flow 1002 may arrive over various radio links, over various serving cells, and over a combination of multiple radio links carrying various serving cells. In such examples, the serving cells may carry the data flow 1002 via one or more PDSCHs that arrive at the destination UE 1054 from the network device 1008, the relay device 1056, and/or from both the network device 1008 and the relay device 1056.

In some examples, the data flow 1002 may include some duplicate data (e.g., on a set of one or more serving cells as indicated), may include complementary data, and/or may include both complementary and duplicate data relative to different PDSCHs the destination UE 1054 receives. In an illustrative and non-limiting example, the network device 1008 may transmit rank 1 to the destination UE 1054, and transmit another rank (different relative to the rank 1 data) to relay device 1056. In such examples, the PDSCHs include data that the destination UE 1054 may receive and/or process as distinct portions of one data flow (e.g., a first portion and a second portion, etc.). In addition, or alternatively, the PDSCHs may include data that the destination UE 1054 may treat as distinct portions of two different data flows. The UE 1054 may receive control messaging from the network device 1008 and/or from the relay device 1056 ahead of receiving the one or more data flows, where the control messaging indicates how the destination UE 1054 is to receive and/or process the distinct portions of the data flow(s).

In some examples, the second portion of the data flow may arrive via multiple relay links, such as over a first relay link between the destination UE 1054 and a first relay device, and over a second relay link between the destination UE 1054 and a second relay device. In such examples, the PDSCHs include data that the destination UE 1054 may receive and/or process as distinct portions of one data flow (e.g., a first downlink (DL) portion, a second relay portion, and a third relay portion; a first DL portion, a second DL portion, and a third relay portion; a first DL portion, a second DL portion, a third relay portion, and a fourth relay portion, etc.).

In an illustrative example, the network device 1008 may indicate that data transmitted to the destination UE 1054 on a specific serving cell includes data that the destination UE 1054 may receive in duplicates over multiple serving cells and from multiple transmitting devices (e.g., the network device(s) 1008 and/or the relay UE 1056). In such examples, the destination UE 1054 may receive the data from one or the other transmitting devices relative to the indicated serving cell 1008. When the destination UE 1054 receives the data successfully (e.g., from network device 1008, from relay UE 1056, etc.), the destination UE 1054 may discontinue monitoring for the duplicate data (e.g., indicated as such) relative to the corresponding serving cell on the relay link 1026 or on the primary radio link 1024.

### Monitoring Channel Quality for Optimizing Relay Efficacy

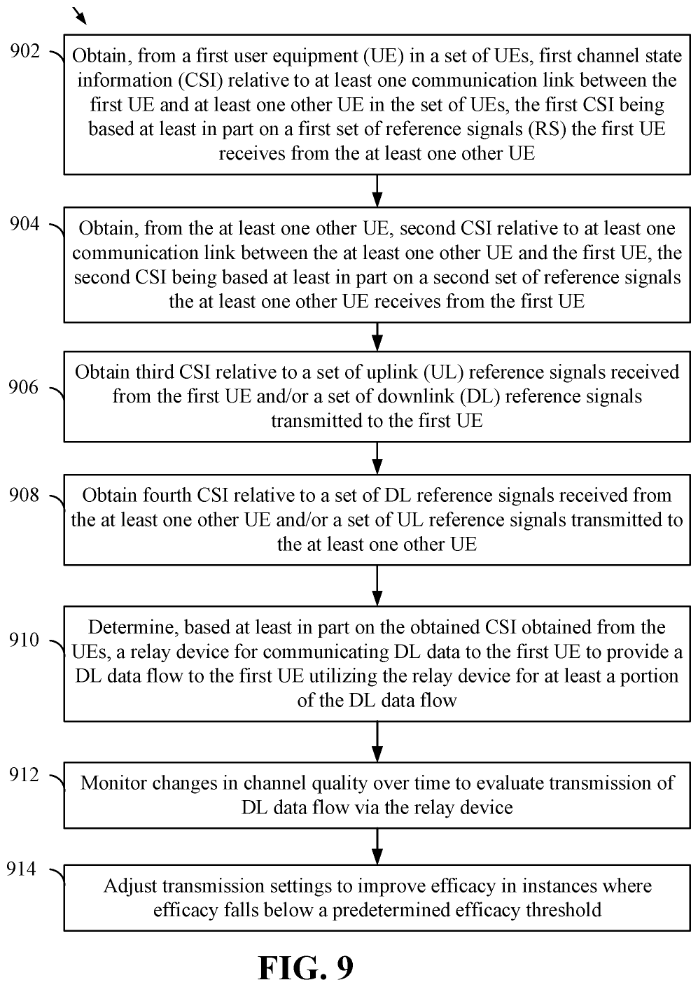

FIG. 9 is a flow chart illustrating an exemplary process 900 for identifying a suitable relay user equipment (UE) for serving as a relay device in accordance with some aspects of the present disclosure. As described herein, a particular implementation may omit some or all features, and may not require some illustrated features to implement all embodiments. In some examples, the process 900 may be carried out by the scheduling entity 1700 illustrated in FIG. 17. In some examples, any suitable apparatus or means for carrying out the functions or algorithm described herein.

At block 902, one or more scheduling entities 108 (e.g., the network device(s) 704) may obtain channel state information (CSI) from a first user equipment (UE) 710 (e.g., a destination UE in some examples). The CSI may include a set of channel state coefficients, a set of channel quality information (CQI) measurements (e.g., throughput, signal-to-noise ratio (SNR), etc.). In an example, the scheduling entity 108 may obtain the CSI relative to at least one communication link 722 (e.g., a third radio link). The communication link 722 may be a radio link between the first UE 710 (e.g., a relay device in some examples) and a second UE 712. The first UE 710 and the second UE 712 may be part of a set of UEs (e.g., a UE group 706). In such instances, the CSI may be based at least in part on a first set of reference signals (RS) the first UE 710 receives from the second UE 712. The first UE 710 may measure the first set of reference signals to determine a set of CQI measurements for including in a channel state report (e.g., a group UE report, an individual channel state report, etc.).

At block 904, the one or more scheduling entities 108 may obtain, from the second UE 712, CSI relative to at least one communication link (e.g., a radio sidelink) between the second UE 712 and the first UE 710. In such instances, the CSI may be based at least in part on a second set of RSs the second UE 712 receives from the first UE 710. In an illustrative example, the first UE 710 may transmit a set of CSI-RSs to the second UE 712. The second UE 712 may receive and measure the set of CSI-RSs to determine a set of channel state information details relative to the communication link 722 between the first UE 710 and the second UE 712. In some examples, the second UE 712 may provide the set of channel state information details to the one or more scheduling entities 108 (e.g., in a group report, etc.). While the CQI may be the same regardless of direction for the radio links between the first UE 710 and the second UE 712, this is not necessarily the case, and as such, CQI may be measured and reported for CSI-RSs transmitted from the first UE 710 to the second UE 712 and from the second UE 712 to the first UE 710.

At block 906, the one or more scheduling entities 108 (e.g., network device 704) may obtain a third set of CSI measurements relative to a set of uplink (UL) reference signals received from the first UE 710 and/or a set of downlink (DL) reference signals transmitted to the first UE 710. In this way, the network device 704 may determine channel quality information (CQI) for the radio link 720 between the network device 704 and the first UE 710. The network device 704 may use the CQI for the radio link 720 as a reference to determine when the network device 704 may transmit a wider data flow to the first UE 710 using a potential relay link that may provide a portion of the data flow to the first UE 710.

At block 908, the one or more scheduling entities 108 may obtain a fourth set of CSI measurements relative to a set of DL reference signals received from the second UE 712 and/or a set of UL reference signals transmitted to the second UE 712. In an example, the network device 704 may transmit a CSI-RS to the second UE 712 in a DL transmission. The network device 704 may measure the set of UL reference signals received from the second UE 712 to characterize the CQI of the second radio link 724 and (assuming channel reciprocity) to determine a DL precoding matrix for precoding subsequent signals to the second UE 712.

At block 910, the one or more scheduling entities 108 may determine, based at least in part on the CSI obtained from the first UE 710 and the second UE 712, a relay device (e.g., the first UE 710) for communicating DL data to the second UE 712 (e.g., a destination UE). In such examples, a network device 704 may provide a DL data flow to the destination UE 712 utilizing the relay UE 710 for transmitting (e.g., carrying) at least a portion of the DL data flow.

FIG. 10 is a schematic illustration of the relay configuration in an example involving no relay UE(s) as part of the first radio link 1024. In some examples, both radio links may include relay UE(s) as part of the data flow 1002 from the network device(s) 1008 to the destination UE 1054. The third radio link 1026 may represent any suitable radio link, such as a sidelink. In some examples, the one or more relay UE(s) 1056 and the destination UE 1054 may implement the third radio link 1026 using a PC5 protocol. In some examples, the network device(s) 1008 may determine that the third radio link 1026 and the second radio link 1020, when taken together, provide a channel quality that satisfies a particular channel quality threshold. In this way, the network device(s) 1008 may provide the data flow 1002 to the destination UE 1054 with the relay UE(s) 1056 relaying a portion of the data flow 1002 to the destination UE 1054.

At block 912, the one or more scheduling entities 108 (e.g., the network device(s) 1008) may monitor for any changes (e.g., degradations, improvements in other radio links, etc.) in channel quality over time to evaluate transmission of the DL data flow 1002 via the relay UE 1056. In some examples, the network device(s) 1008 may determine upon measuring a new set of reference signals or from receiving a channel state report from one or more UEs of the UE group that the channel quality of the second radio link 1020 or the third radio link 1026 has degraded below a channel quality threshold. In such instances, the network device(s) 1008 may determine a new relay device and/or may determine not to implement a relay configuration for a duration of time due to the degrading channel quality.

At block 914, the one or more scheduling entities 108 may adjust a set of transmission settings to improve efficacy. In an example, a network device 1008 may determine that the channel quality for the relay link 1026 has deteriorated, such that the relay efficacy falls below a predetermined efficacy threshold. In some examples, the network device(s) 1008 may increase the transport block (TB) size for the relay data transmitted via relay UE(s) 1056 when the channel quality of the relay link 1026 falls below the channel quality threshold. In an example, when a radio link (e.g., the third radio link 1026) between the destination UE 1054 and the relay UE 1056 worsens in terms of channel quality, the relay UE 1056 may adjust the TB size for the second portion of the data flow 1002 that the relay UE 1056 is to relay to the destination UE 1054. In such examples, the relay UE 1056 may increase the TB size of the relay data to compensate for the worsened channel state of the third radio link 1026.

In some examples, the network device(s) 1008 may initiate the relay UE 1056 and the destination UE 1054 to monitor for the adjusted TB size upon the network device(s) 1008 determining such degradation in the channel quality that may be compensated for with the adjusted TB size. In an example, the network device 1008 may provide scheduling information to the relay UE(s) 1056 and to the destination UE 1054 to schedule the data flow 1002 to reflect the adjusted TB size and to compensate for the deteriorating radio link(s) in a given relay configuration.

In another example, the network device 1008 may request from another UE within the UE group a channel state report characterizing a communication link between the other UE and the destination UE 1054. In some instances, the network device 1008 may transition from using the second UE 1056 as the relay device to using this other UE as the relay device, for example, when the channel quality appears suitable for the communication link between the UEs of the UE group. In another example, the network device 1008 may adjust its power settings for transmitting data over the second radio link 1020. In any event, the network device 1008 may adjust transmission settings, including to transmission settings of the relay UE 1056 via control information, to compensate for a deteriorating radio link in a given relay configuration.

### Network Transmitting Data Flow to a Destination Device

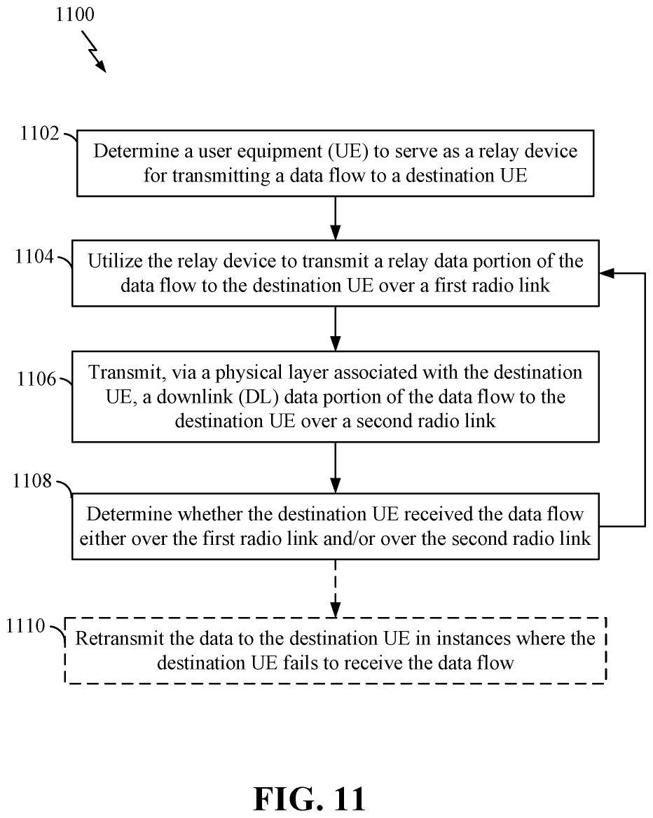

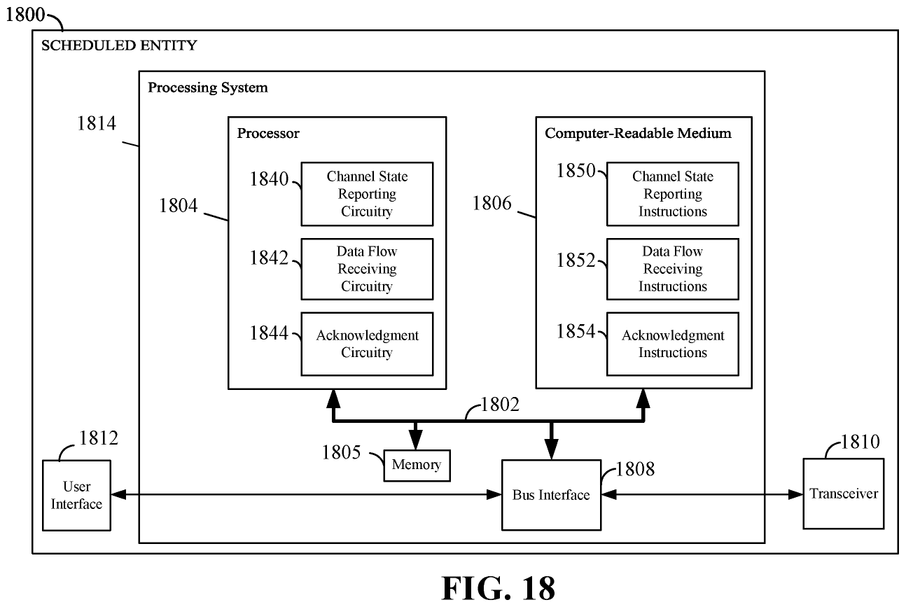

FIG. 11 is a flow chart illustrating an exemplary process 1100 for transmitting data from an upstream scheduling entity 108 (e.g., a network device 1008) to a destination UE 106 in accordance with some aspects of the present disclosure. As described herein, a particular implementation may omit some or all features, and may not require some illustrated features to implement all embodiments. In some examples, the process 1100 may be carried out by the scheduling entity 1700 illustrated in FIG. 17 and/or the scheduled entity 1800 illustrated in FIG. 18. In some examples, any suitable apparatus or means for carrying out the functions or algorithm described herein.

At block 1102, an upstream scheduling entity 108 (e.g., network device(s) 1008) may determine a user equipment (UE) to serve as a relay UE 1056. In an example, the network device 1008 may determine the relay UE 1056 for transmitting a data flow 1002 to a destination UE 1054. In some examples, a network device 1008 may receive UE group information from the destination UE 1054, from one or more relay UE(s) 1056, and/or from another UE in the UE group. In some examples, the network device 1008 may determine, from the UE group information, to utilize one or more UEs as the relay UE(s) 1056. In an example, the UE group information may specify that one or more specific UEs 106 are to serve as relay UE(s) 1056. In an illustrative and non-limiting example, these may be dedicated relay nodes that a user may install in one or more various locations to serve as a relay UE for a destination UE 1054. In some examples, these UEs 106 may include any UE 106 as described herein, including, but in no way limited to those described with reference to the example communication network 500 of FIG. 5. In some examples, these UEs 106 need not necessarily be in an awake state. In an example, the relay UE(s) 1056 may include a laptop that is in a sleep state, but that in its sleep state may still be able to transmit reference signals to the destination UE 1054. The network device(s) 1008 may utilize the laptop as a relay UE 1056, in which case the laptop may potentially alter its state from the sleep state to be able to receive relay data from the network device 1008 and transmit the relay data to the destination UE 1054.

In some examples, the destination UE 1054 is operated by User A and the one or more relay UE(s) 1056 are operated by one or more other users (e.g., User B). In such examples, the upstream scheduling entity 108 may determine a UE 106 to serve as a relay UE 1056 based on requested channel state information (CSI) reports. The CSI reports may include channel quality information (CQI) for various radio links (e.g., the third radio link 1026) the destination UE 1054 has with one or more other UEs 106 in the UE group. The CQI may provide the network device(s) 1008 with sufficient information to rank the radio links to determine which UE in the UE group to utilize as a relay UE 1056.

In some examples, the network device(s) 1008 may request CSI reports from the UEs 106 of the UE group in instances where the destination UE 1054 and the one or more relay UE(s) 1056 correspond to User A. In such examples, the UEs may additionally or alternatively provide UE group information to the network device(s) 1008. The network device(s) 1008 in such instances may determine which UEs 106 in the UE group to utilize as a relay UE 1056 based on a combination of the CSI reports (e.g., a UE group report, CQI of the third radio link 1026, etc.), and the UE group information received from the UE group (e.g., from the destination UE 1054).

At block 1104, the network device(s) 1008 may utilize the relay UE(s) 1056 to transmit a relay data portion of the data flow 1002 to the destination UE 1054 over a second radio link 1020 (e.g., a first radio link in a plurality of relay radio links). In some examples, the network device(s) 1008 may transmit a physical downlink shared channel (PDSCH) carrying a relay data portion of the data flow 1002. In such examples, the network device(s) 1008 may include one or more indications that signal to the relay UE(s) 1056 that the relay data is for the destination UE 1054. In an example, the network device(s) 1008 may transmit the relay UE(s) 1056 such indications as part of a physical downlink control channel (PDCCH) or as part of a signaling protocol using upper or lower layers of a protocol stack to earmark the relay data for the destination UE 1054 as the relay data is transmitted through the relay UE(s) 1056.

In addition, the relay UE(s) 1056 may, upon receiving the relay data portion of the data flow, may then transmit (e.g., forward) the relay data portion of the data flow 1002 to the destination UE 1054. In an example, the relay UE(s) 1056 may forward the relay data portion to the destination UE 1054 over a radio link (e.g., the third radio link 1026). In some examples, the relay UE 1056 may transmit the relay data portion of the data flow at the physical layer. In some examples, the relay UE 1056 may transmit a control channel (e.g., a physical sidelink control channel (PSCCH)) to the destination UE 1054. The PSCCH may include sidelink control information (SCI) that schedules a data transmission to the destination UE 1054. Accordingly, the relay UE 1056 may transmit the relay data portion of the data flow. In an example, the relay UE 1056 may transmit a physical sidelink shared channel (PSSCH) that carries the relay data portion of the data flow to the destination UE 1054. In some instances, the destination UE 1054 may receive the PSSCH according to the SCI of the PSCCH.

In another example, the relay UE 1056 may transmit the relay data portion of the data flow to the destination UE 1054. The destination UE 1054 may receive a physical downlink control channel (PDCCH) from the network device(s) 1008. The PDCCH may include downlink control information (DCI). In some examples, the DCI may schedule the relay data transmission from the relay UE 1056 to the destination UE 1054 over the third radio link 1026. In such examples, the destination UE 1054 may receive the DCI directly from the network device(s) 1008 with the DCI scheduling the relay data transmission between the relay UE(s) 1056 and the destination UE 1054.

At block 1106, the network device(s) 1008 may transmit, at a physical layer, a downlink (DL) data portion of the data flow to the destination UE 1054 over a first radio link 1024. In an example, a network device 1008 may transmit the DL data portion of the data flow directly to the destination UE 1054. In some examples, the network device 1008 may further transmit an indication to the destination UE 1054 that a UE in the UE group is operating as a relay UE 1056. In such instances, the network device 1008 may indicate to the destination UE 1054 that the destination UE 1054 is to receive a data flow from the network device 1008 that may include a relay data portion via a relay UE 1056. In another example, the network device 1088 may indicate this to the destination UE 1054 implicitly by requesting channel state information from the destination UE 1054 for radio links the destination UE 1054 has with other UEs in the UE group.

At block 1108, the network device(s) 1008 may determine whether the destination UE 1054 received the data flow. In some examples, the network device 1008 may determine whether the destination UE 1054 received the data flow over at least one of: the first radio link 1024, or the third radio link 1026. In an example, the destination UE 1054 may receive the downlink (DL) data from the network device 1008 over the first radio link 1024. The destination UE 1054 may transmit an acknowledgment message to the network device(s) indicating the destination UE 1054 received the data flow. In another example, the destination UE 1054 may receive the relay data from the network device 1008 over the third radio link 1026. The destination UE 1054 may transmit an acknowledgment message to the network device(s) 1008 indicating the destination UE 1054 received the data flow. In some instances, the network device 1008 may consider the data flow transmission successful when the data flow arrives over any radio link. The network device 1008 may not necessarily need to determine which radio link was the radio link the destination UE 1054 used to receive the data flow 1002. In such instances, the network device 1008 may continue to proceed according to block 1104 and utilize the relay UE 1056 to transmit additional relay data to the destination UE 1054.

At block 1110, the network device(s) 1008 may optionally retransmit the data to the destination UE 1054. The network device 1008 may do so in instances where the destination UE 1054 fails to receive the data flow 1002. The network device 1008 may determine the destination UE 1054 failed to receive the data flow 1002 based on automatic repeat request (HARQ) feedback received from the destination UE 1054 and/or the relay UE(s) 1056.

### Transmitting Relay Data to a Destination Device

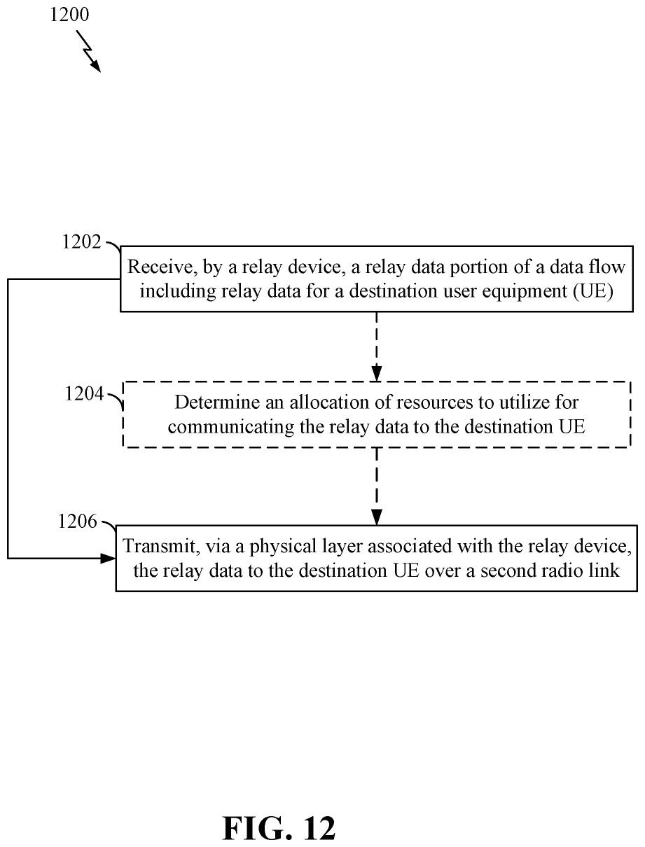

FIG. 12 is a flow chart illustrating an exemplary process 1200 for receiving and transmitting relay data to a destination UE in a second portion of a data flow in accordance with some aspects of the present disclosure. As described herein, a particular implementation may omit some or all features, and may not require some illustrated features to implement all embodiments. In some examples, the process 1200 may be carried out by the scheduling entity 1700 illustrated in FIG. 17 and/or the scheduled entity 1800 illustrated in FIG. 18. In some examples, any suitable apparatus or means for carrying out the functions or algorithm described herein may carry out the process 1200. In some instances, a relay UE may implement both scheduling entity and scheduled entity functions and as such, a relay UE may include circuitry described with reference to FIGS. 17 and/or 18 in various instances.

At block 1202, a relay UE 1056 may receive a relay data portion of a data flow 1002 including relay data for a destination user equipment (UE) 1054. In an example, the relay UE 1056 may receive an indication (e.g., a control message, a request, etc.) from the network device 1008 that the relay data is destined for another device (e.g., a destination UE 1054) and not for the relay UE 1056.

In some examples, the indication may include an implicit indication. In an example, the implicit indication may include a radio network temporary identifier (RNTI). The network device 1008 may implicitly indicate the RNTI with a transmission of the relay data to the relay UE 1056. In such examples, the RNTI may correspond to the destination UE 1054 and as such may implicitly indicate that the relay data is destined for a particular destination (e.g., the destination UE 1054). That is, various different RNTIs may indicate different destinations or destination UEs regarding certain data. In another example, an implicit indication may include a mapping between RNTI and device/data ID. Another example of implicit indication may include a physical downlink control channel (PDCCH) demodulation reference signal (DMRS) scrambling IDs. In an example, the network device 1008 may indicate an allocation of DMRS resources and/or an implicit indication of a DMRS configuration indicating the relay data is for a destination UE 1054.

In some examples, the indication may include an explicit indication. In an example, the indication may include a downlink control information (DCI) field to indicate the device ID and/or data ID. In such examples, the relay UE 1056 may utilize the device/data ID to determine the relay data is for the destination UE 1054. In another example, a device/data ID mapping can be configured by a higher layer (e.g., an application layer, an adaptation protocol layer). The relay UE(s) 1056 may access the device/data ID mapping and determine the relay data is for a destination UE 1054 according to the mapping.

In some examples, the indication (e.g., one or more control message(s), a request for particular channel state information (CSI), etc.), from the network device 1008, may include both an implicit and explicit indication. In an illustrative and non-limiting example, a control message may include a DCI field, in addition to RNTI, where the DCI field indicates which part of the data flow corresponds to the relay portion of the data flow (e.g., the portion of the data flow that carries relay data for the downstream destination UE 1054). In some examples, the relay UE 1056 may isolate and forward the relay data portion of the data flow to the destination UE 1054 according to a control message. The relay UE 1056 may also receive its own data (e.g., data indicated as being for the relay UE 1056) without forwarding the data. In such instances, the relay UE 1056 may, based at least in part on the indication, decode the data intended for the relay UE 1056 and forward the relay data to the destination UE 1054.

In some examples, the relay UE 1056 may determine from the indication that the relay UE 1056 is to forward data to multiple destination UEs 1054 downstream from the relay UE 1056. That is, the upstream network device(s) 1008 may transmit data to multiple destination UEs 1054 and may utilize a single relay UE 1056 to transmit relay data portions to the multiple destination UEs 1054. The network device 1008 may transmit the relay data, in such instances, together in a single data channel or may transmit the relay data in separate data channels to the relay UE 1056. In any case, the relay UE 1056 may determine instructions, via control messaging from the downstream UE(s) or the network device, on identifying and handling the relay data so that the relay data may arrive at its intended destination.

In some examples, the data to the destination UE 1054 may be the same as or different from the data to the relay UE(s) 1056. In an example, the data transmitted via the first radio link 1024 may be the same as the relay data transmitted via the third radio link 1026. In such examples, the destination UE 1054 may receive the same data over the various radio links. In another example, the destination UE 1054 may receive the data over at least one radio link and discontinue monitoring for the data on the other radio link until the destination UE 1054 is to receive a next piece of a data flow over the various radio links.

At block 1204, the relay UE 1056 may optionally determine an allocation of resources to utilize for communicating the relay data to the destination UE 1054. In an example, the relay UE 1056 may identify a set of resource elements (REs) or resource blocks (RBs) for transmitting the relay data to the destination UE 1054. In some examples, the relay UE 1056 identifies an allocation of resources according to downlink control information (DCI) the relay UE 1056 receives from the network element 1008. The network element 1008 may indicate to the destination UE 1054 the allocation of resources corresponding to the DCI, such that the relay UE 1056 may utilize the allocation of resources to communicate the relay data to the destination UE 1054. In such examples, this may be optional in that the network element 1008 may determine the allocation of resources rather than the relay UE 1056.

At block 1206, the relay UE 1056 may transmit, via a physical layer of the relay UE 1056, the relay data to the destination UE 1054 over a third radio link 1026. In some examples, the relay UE 1056 may do so based on a pre-defined rule is applied to indicate the data resource allocation. In an example, this pre-defined rule may follow a fixed slot offset, same frequency resource, a modulation and coding scheme (MCS), and so forth. In an example, the relay UE 1056 may receive the relay data. After a fixed slot offset, the relay UE 1056 may transmit the relay data to the destination UE 1054. In some examples, the relay UE 1056 may transmit the relay data to the destination UE 1054 without transmitting a sidelink control channel. In an example, the relay UE 1056 may transmit the relay data to the destination UE 1054 following a fixed slot offset, such that the destination UE 1054 receives the relay data according to a timer that tracks the fixed slot offset, rather than based on control information.

In some examples, the relay UE 1056 may be the dominant entity for controlling the relay data transmission activities from the relay UE 1056 to the destination UE 1054. In an example, the relay device 1056 may transmit control and data channels using a sidelink (physical sidelink control channel (PSCCH)/physical sidelink shared channel (PSSCH)). In another example, the relay UE 1056 may configure a time period is configured for data transmission, which may be different for different relay nodes. This may include an expiration time period that causes the relay data to expire if not transmitted during the time period.

In some examples, the network device 1008 may be the dominant entity for controlling the relay data transmission activities from the relay UE 1056 to the destination UE 1054. In such examples, the control is from the network device 1008 (e.g., physical downlink control channel (PDCCH)) and the relay data is from the relay UE 1056 (e.g., PSSCH). In some examples, when the network device 1008 transmits various data channels to the destination UE 1054, the network device 1008 may indicate the PSSCH setting to the relay UE 1056 and to the destination UE 1054.

In some examples, the network device 1008 may configure semi-persistent scheduling (SPS) transmission for transmitting the relay data. In such examples, the relay UE 1056 may implement the SPS transmission to transmit the relay data to the destination UE 1054.

In some examples, the relay data may include a same transport block (TB) size as the downlink (DL) data transmitted over the primary radio link 1054. In such examples, the relay UE 1056 may transmit (e.g., forward) the data of the data flow to the destination UE 1054. In another example, the relay configuration may utilize a higher layer procedure, for example, in instances where the data of the data flow is not the same TB size. In an example, the relay UE 1056 may utilize a smaller TB size in some instances for the relay data (e.g., relative to the downlink data). In some examples, a smaller TB size may be used for cases involving high priority data. In another example, a different TB size may be used in response to link quality variation (e.g., worsening channel quality on a particular radio link). In an example, the relay UE 1056 may utilize a smaller TB size to compensate for channel quality variations for the various radio links in the relay configuration. In some examples, the relay UE 1056 may engage in TB segmentation to segment the TBs corresponding to the relay data. In such examples, TB segmentation may yield multiple (e.g., additional) control and/or data channels for transmitting the relay data to the destination UE 1054. In an example, the relay UE 1056 may transmit the relay data to the destination UE 1054 over multiple PSSCHs following the relay UE 1056 segmenting the TBs of the relay data.

### Receiving the Data Flow Over Multiple Radio Links

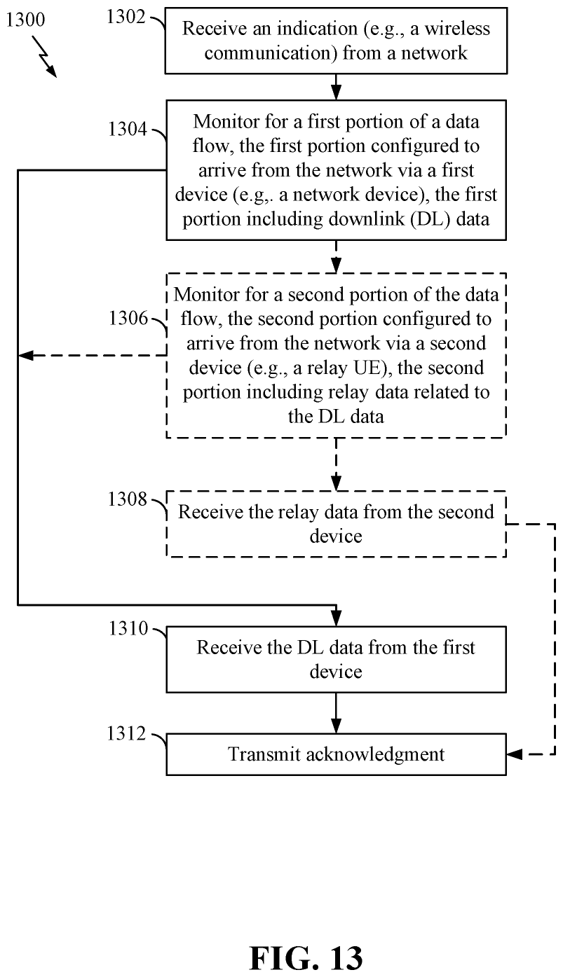

FIG. 13 is a flow chart illustrating an exemplary process 1300 for a scheduled entity 106 to receive a data flow 1002 from an upstream network device 1008 over multiple radio links including a relay link (e.g., the third radio link 1026) in accordance with some aspects of the present disclosure. As described herein, a particular implementation may omit some or all features, and may not require some illustrated features to implement all embodiments. Any suitable apparatus or means for carrying out the functions or algorithm described herein.

At block 1302, a scheduled entity 106 (e.g., a destination UE 1054, a road side unit (RSU), a first device, etc.) may receive an indication (e.g., a wireless communication) from a network. The indication may include a request for a group CSI report. In another example, the indication may include a physical downlink control channel (PDCCH) scheduling data for the destination UE 1054. In an illustrative example, the received indication may include a control message. In some examples, the indication may received from the upstream scheduling entity 108 (e.g., the network device 1008). In any case, the indication may be configured to indicate that the scheduled entity 106 is to monitor a plurality of radio links, including a relay link, for at least one data flow 1002 from the network device 1008. In other words, the indication may be configured to indicate that the network device 1008 is transmitting a data flow 1002 to the destination UE 1054 (e.g., the first device) using a relay UE to transmit a relay data portion of the data flow 1002 to the destination UE 1054.

In some examples, the network device 1008 may transmit an indication configured to indicate for the destination UE 1054 the existence of a relay UE 1056. In an example, the network device 1008 may do so using a CSI report format. In an example, in instances where, the network device 1008 configures CSI report for channels between relay UE 1056 and destination UE 1054, the destination UE 1054 may assume relay node exists. In some examples, the destination UE 1054 may assume the relay node exists for a preconfigured time period following the CSI report configuration message. In some examples, the network device 1008 may provide a high layer activation (MAC-CE) of the device/data ID to activate the relay UE 1056.

In another example, the network device 1056 may provide a downlink control information (DCI) indication of device/data ID for the relay UE 1056 (e.g., in instances where the relay configuration is network device dominant). In some examples, the network device 1056 may indicate a relay resource allocation relative to a fixed timeline for the destination UE 1054 to use to receive the data flow. In another example, the network device 1056 may indicate a time period for the relay UE 1056 to receive and decode the relay data. In an example, this time period may include a flexible timeline that may including floating time intervals throughout a duration of a relay configuration.

At block 1304, the destination UE 1054 may monitor for the data flow 1002 from the network device 1008. The destination UE 1054 may monitor for the data flow 1002 on a first radio link 1024. That is, the destination UE 1054 may monitor for the data flow 1002, where the destination UE 1054 may monitor a particular set of resources (e.g., resource elements, resource blocks) for the data flow 1002 from the network device 1008. In an illustrative and non-limiting example, the destination UE 1054 may monitor for the data flow 1002 by providing power to one or more power amplifiers associated with the transceiver of the destination UE 1054 (e.g., the transceiver 1810 of FIG. 18). The destination UE 1054 may selectively provide power to a first set of power amplifiers associated with the transceiver. In this way, the destination UE 1054 may monitor the particular set of resources to potentially receive the first portion of the data flow 1002 that may arrive over the first radio link 1024. In an example, the data flow 1002 may be expected to arrive from any upstream network element over the first radio link 1024.

At block 1306, the destination UE 1054 may monitor for the data flow 1002 from the network device 1008 over a relay link. In some examples, the destination UE 1054 may be configured to monitor for a relay portion of the data flow 1002 over a relay radio link. As with the monitoring for the first portion of the data flow 1002 corresponding to the first radio link 1024, the destination UE 1054 may monitor for the relay portion of the data flow 1002, in some instances, by powering on one or more power amplifiers associated with the transceiver of the destination UE 1054. In an illustrative and non-limiting example, the destination UE 1054 may selectively provide power to a second set of power amplifiers associated with the transceiver. In this way, the destination UE 1054 may monitor the particular set of resources to potentially receive the relay portion of the data flow 1002 that may arrive over the relay radio link 1026. That is, by monitoring the particular set of communication resources configured to correspond to the relay data of the data flow 1002 or the downlink (DL) data of the data flow 1002, the destination UE 1054 may receive the data sent via the corresponding radio links 1024/1026. The destination UE 1054 may additionally or alternatively receive the data flow 1002 from the network device 1008 over a separate radio link.

At block 1308, the destination UE 1054 may receive the data flow from the relay UE 1056 as relay data. In an example, the destination UE 1054 may receive a relay data portion of the data flow 1002 via physical layer of a user plane protocol stack. The destination UE 1054 may additionally or alternatively receive the data flow 1002 from the network device 1008 over a separate radio link.

At block 1310, the destination UE 1054 may receive the data flow 1002 from the network device 1008. In some examples, the destination UE 1054 may receive the DL data, and not the relay data. This may occur even where the destination UE 1054 was monitoring for the relay data. In an example, if the DL data arrives and can be decoded within a predetermined timeframe, and the destination UE 1054 has not yet detected a PSSCH carrying the relay data, then the destination UE 1054 may advantageously stop monitoring the sidelink (e.g., conserving power resources). In another example, the destination UE 1054 may receive the DL data and stop monitoring for the relay data (e.g., temporarily) or the destination UE 1054 may receive the relay data from the relay UE 1056 and may stop monitoring for the DL data. In such instances, the destination UE 1054 receives the data flow either as represented via the DL data or the relay data. In an illustrative and non-limiting example, the destination UE 1054 may discontinue monitoring by powering down one or more power amplifiers associated with a transceiver of the destination UE 1054. In an example, the destination UE 1054 may temporarily de-power a set of power amplifiers associated with receiving the relay data over the relay radio link 1026 upon having successfully received the DL data over the radio link 1024 within the predetermined timeframe.

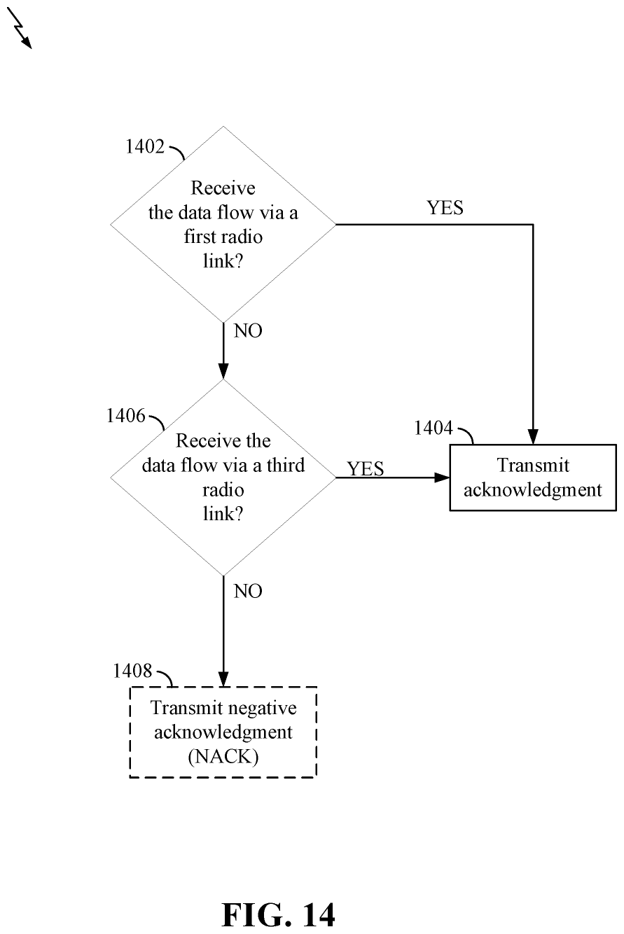

At block 1312, the destination UE 1054 may transmit hybrid automatic repeat request (HARQ) acknowledgment (ACK) feedback upon receiving the data flow over the first radio link 1024 or the third radio link 1026. FIG. 14 describes an example HARQ ACK feedback technique.

### Acknowledgment Feedback

FIG. 14 is a flow chart illustrating an exemplary process 1400 for a scheduled entity (e.g., a user equipment (UE)) acknowledging reception of a data flow received from an upstream scheduling entity (e.g., a base station (BS)) and with assistance from a relay node in accordance with some aspects of the present disclosure. As described herein, a particular implementation may omit some or all features, and may not require some illustrated features to implement all embodiments. In some examples, the process 1400 may be carried out by the scheduled entity 1800 illustrated in FIG. 18. In some examples, any suitable apparatus or means for carrying out the functions or algorithm described herein may carry out the process 1400.

At block 1402, the scheduled entity 106 (e.g., the destination UE 1054) may determine whether the destination UE 1054 received the data flow 1002 via a first radio link 1024. In instances where the destination UE 1054 determines that it has successfully received the data flow 1002 via the first radio link 1024 (YES at block 1402), the destination UE 1054 may transmit hybrid automatic repeat request (HARQ) acknowledgment (ACK) feedback to the network device 1008. In such examples, the destination UE 1054 may forego transmitting an acknowledgment to the relay UE 1056, even in instances where the destination UE 1054 receives the data flow over the third radio link 1026.

In some examples, the destination UE 1054 may not receive the data flow 1002 via the first radio link 1024. In such instances (NO at block 1402), the destination UE 1054 may determine whether the destination UE 1054 received the data flow 1002 via a third radio link 1026 (e.g., a relay radio link).

At block 1404, the destination UE 1054 transmits hybrid automatic repeat request (HARQ) acknowledgment (ACK) feedback to the network device 1008 in instances where the destination UE 1054 determines that it has successfully received the data flow 1002 via the third radio link 1026 (YES at block 1406). In some examples, the destination UE 1054 may transmit, over the radio link 1024 established between the destination UE 1054 and the network device 1008, the acknowledgment message corresponding to the relay data. The destination UE 1054 may do so when the destination UE 1054 fails to receive the DL data during the first timeframe, and yet receives the relay data during the first timeframe. And with respect to a second timeframe that extends beyond the first timeframe, the destination UE 1054 may transmit, over the radio link 1024 established between the destination UE 1054 and the network device 1008, feedback (e.g., an acknowledgement message) corresponding to the relay data. In an illustrative and non-limiting example, the destination UE 1054 may do so in instances where the destination UE 1054 receives the relay data during the second timeframe and fails to receive the DL data (e.g., in instances where the destination UE 1054 fails to receive the DL data via the radio link 1024 prior to receiving the relay data during the second timeframe). In some examples, the second timeframe extends beyond the first timeframe, and the second timeframe corresponds to the relay data portion of the dataflow 1002 that is to arrive over the radio link 1026 established between the relay device 1056 and the destination UE 1054 via a physical data channel (e.g., a sidelink data channel).

At block 1408, the destination UE 1054 may determine that the HARQ feedback time has expired for both a first HARQ timeline related to the first radio link 1024 and a second HARQ timeline related to the third radio link 1026 has expired. In such instances (NO at block 1406), the destination UE 1054 may transmit a negative acknowledgment (NACK).

In some examples, the relay UE 1056 may transmit a data channel (e.g., a physical sidelink data channel (PSSCH)) to the destination UE 1054, where the data channel includes relay data for the destination UE 1054. The destination UE 1054 may be monitoring for the data channel. However, the destination UE 1054 may fail to receive (e.g., decode) the data channel within a time frame indicated via scheduling information. Accordingly, the destination UE 1054 may, in some instances, transmit a negative acknowledgment (NACK) to the relay UE 1054 as feedback indicating its failure to receive the relay data. The relay UE 1054 may receive, from the destination UE 1054, the NACK indicating the destination UE 1054 failed to decode the data channel within the predetermined time frame corresponding to the scheduling information (applicable to transmittal and receiving of the relay data over the radio link between the destination UE 1054 and the relay UE 1054).

That is, if the destination UE 1054 can successfully decode the data within the first time period, the destination UE 1054 may transmit feedback according to a first HARQ timeline. In this way, the network device 1008 may reduce its feedback buffer. Otherwise, the destination UE 1054 transmits feedback ACK/NACK on a second HARQ timeline.

FIG. 15 is a block diagram conceptually illustrating an example protocol stack for an example scheduled entity and an example scheduling entity according to some examples. The protocol stacks 1500 may include a first protocol stack 1510 for a scheduled entity 106 (e.g., an extended reality (XR)-enabling device) and a second protocol stack 1520 for a scheduling entity 108 (e.g., an extended reality (XR)enabling device). In various examples, the first protocol stack 1510 and the second protocol stack 1520 may be stacked in terms of layers, such that the protocol stacks as “lower” layers and “upper” layers as shown where the upper layers are shown as being stacked above the lower layers, for example.

In addition, the first protocol stack 1510 may have a medium access control (MAC) layer entity 1516, a physical (PHY) layer 1518, etc. as part of the lower layers of the first protocol stack 1510 for the user plane. On the scheduling entity 108 side, the second protocol stack 1520 may have an upper layer 1524 (e.g., an adaptation protocol layer, an application layer, etc.), and may further include a medium access control (MAC) layer entity 1526, a physical (PHY) layer 1528, etc. as part of those lower layers in a similar manner. In an example, the upper layer 1524 may be the counterpart relative to the upper layer 1514 of the one or more scheduled entities 106. Likewise, the MAC layer entity 1526 may be the counterpart relative to the MAC layer entity 1516, and the PHY layer 1528 may be the counterpart relative to the PHY layer 1518. The network device and scheduled entities may utilize various other layers not shown for other purposes and similarly, may utilize various protocol stacks for the user plane relative to the control plane. In a non-limiting example, the first protocol stack 1510 and the second protocol stack 1520 may be relative to a user plane protocol stack.

In some examples, each layer may perform its own dedicated function. In an example, the upper layer 1514 of a scheduled entity 106 may perform various UE group reporting techniques, channel state reporting techniques, or other techniques attributable to an upper layer 1514, such as an application layer or adaptation protocol layer (e.g., data decoding techniques, etc.). In some examples, the physical layer 1514 may perform functions corresponding to those described with reference to data flow receiving circuitry 1842 and/or acknowledgment circuitry 1844, etc. (described with reference to FIGS. 17 and 18).

In some examples, a physical (PHY) layer (e.g., PHY layer 1518) may generally multiplex and map physical channels (e.g., those physical channels described above) to transport channels for handling at a medium access control (MAC) layer entity (e.g., MAC layer entity 1516). Transport channels carry blocks of information called transport blocks (TBs). The transport block size (TBS), which may correspond to a number of bits of information, may be a controlled parameter, based on the modulation and coding scheme (MCS) and the number of RBs in a given transmission.

A person of ordinary skill in the art will understand that the first protocol stack 1510 and second protocol stack 1520 of FIG. 15 may be utilized to execute any one or more of the various techniques of the disclosure, in addition to other techniques that effectively facilitate communication between a scheduled entity 106 (e.g., implementing the first protocol stack 1510) and a scheduling entity 108 (e.g., implementing the second protocol stack 1520).

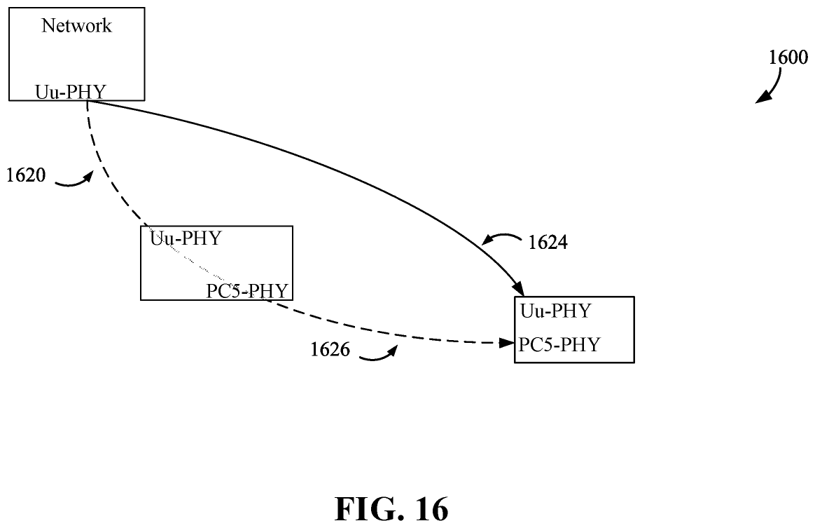

FIG. 16 is a schematic illustration of a network device transmitting a data flow to a destination UE over a plurality of radio links. As shown, an upstream node, such as a upstream scheduling entity 108 (e.g., a base station, a network element, a scheduling user equipment (UE), a road side unit (RSU), etc.) of a communication network 1600 may transmit a data flow to a downstream receiving device over a plurality of radio links. The radio links may include a direct radio link 1624 that connects the upstream scheduling entity. The network may transmit the data flow over radio link 1624, radio link 1620, and radio link 1626 via physical layers. The downstream device may receive the data flow over radio link 1624 and/or over radio link 1626 via the physical layer. The link 1626 may include a PC5 sidelink between UEs. The link 1620 may include a downlink from the network that carries data for the downstream UE. The link 1624 may include a downlink from the network for the downstream UE as well.

In some instances, whichever radio link carries the data flow to the downstream UE before the other includes the data that the downstream UE may proceed with for further data processing. That is, the downstream UE may receive the data flow over radio link 1626 prior to the data flow arriving over radio link 1624. As such, the downstream UE may discontinue monitoring radio link 1624 for a brief time because the downstream UE already received the data flow over the radio link 1626. In instances where the data is not duplicative (e.g., redundant), the downstream UE may continue monitoring radio link 1624 for the data flow (e.g., via the Uu protocol at the physical layer). In some instances, this may be regardless of whether the downstream UE receives the data flow over radio link 1626.

### Scheduling Entity

FIG. 17 is a block diagram conceptually illustrating an example of a hardware implementation for a scheduling entity 1700 employing a processing system 1714. For example, the scheduling entity 1700 may be a user equipment (UE), such as a UE illustrated in any one or more of FIGS. 1, 2, 3, 5, 6, 7, and/or 10. In another example, the scheduling entity 1700 may be a base station as illustrated in any one or more of FIGS. 1, 2, 3, 5, 6, and/or 7. In some examples, the scheduling entity 1700 represents a scheduling entity 108 (e.g., a network device 1008). In an example, the scheduling entity 1700 may represent an example of a hardware implementation for a scheduling entity 108 as discussed throughout this disclosure.

In some examples, the scheduling entity 1700 may represent a hardware implementation for a device that operates as a scheduling entity in some instances and as a scheduled entity 106 (e.g., scheduled entity 1800). In an example, the relay UE(s) 1056 may be scheduling communication for delivery to a downstream device (e.g., the destination UE 1054). In addition, or alternatively, the relay UE(s) 1056 may in some instances serve as a scheduled entity 106 as well, in which case the relay UE(s) 1056 may include both hardware for relaying activities. That is, a relay UE 1056 may include hardware for receiving data from network device(s) 1008 (e.g., data flow receiving circuitry 1842) and relaying the data as relay data to the destination UE 1054 (e.g., data flow scheduling circuitry 1740).

The scheduling entity 1700 may include a processing system 1714 having one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 1700 may be configured to perform any one or more of the functions described herein. For example, the processor 1704, as utilized in a scheduling entity 1700, may be configured (e.g., in coordination with the memory 1705 and the transceiver 1710) to implement any one or more of the processes and procedures described herein, for example, with reference to FIGS. 8, 9, and/or 11.

The processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702 and a transceiver 1710. The transceiver 1710 provides a communication interface or means for communicating with various other apparatus over a transmission medium. Depending upon the nature of the apparatus, a user interface 1712 (e.g., keypad, display, speaker, microphone, joystick) may also be provided. Of course, such a user interface 1712 is optional, and some examples, such as a base station (BS), may omit it.

In some aspects of the disclosure, the processor 1704 may include data flow scheduling circuitry 1740 configured (e.g., in coordination with the memory 1705 and/or the transceiver 1710) for various functions, including, e.g., transmitting a physical control channel to one or more UEs or transmitting a physical data channel (e.g., a physical downlink shared channel (PDSCH), a physical sidelink shared channel (PSSCH, etc.) as described herein. For example, the data flow scheduling circuitry 1740 may be configured to implement one or more of the functions described herein, for example, with reference to FIGS. 8-16.

The processor 1704 may further include relay identification circuitry 1742 configured (e.g., in coordination with the memory 1705 and the transceiver 1710) for various functions including, e.g., identifying a relay UE for serving as a relay device (e.g., as shown in block 806 of FIG. 8 and block 910 of FIG. 9). In some examples, the relay identification circuitry 1742 may also be configured to obtain channel state information and/or UE group information as shown in block 802 of FIG. 8 and blocks 902-908 of FIG. 9.

The processor 1704 is responsible for managing the bus 1702 and general processing, including the execution of software stored on the computer-readable medium 1706. The software, when executed by the processor 1704, causes the processing system 1714 to perform the various functions described herein for any particular apparatus. The processor 1704 may also use the computer-readable medium 1706 and the memory 1705 for storing data that the processor 1704 manipulates when executing software.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706. The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1706 may store computer-executable code that includes data flow scheduling instructions 1750 that configure a scheduling entity 1700 for various functions, including, e.g., communicating with UEs according to communication methods described herein. For example, the data flow scheduling instructions 1750 may be configured to cause a scheduling entity 1700 to implement one or more of the functions described herein, for example, with reference to FIGS. 8, including, e.g., block 808, and blocks 1204 and 1206 of FIG. 12. The relay identification instructions 1752 may be configured to cause a scheduling entity 1700 to implement one or more of the functions described herein, for example, with reference to FIGS. 8 and 9, including, e.g., blocks 806 and/or 910.

In some examples, the scheduling entity 1700 (e.g., an apparatus) for wireless communication includes means for transmitting a data flow including multiple portions to a destination UE over multiple radio links, and means for receiving HARQ-ACK information indicating whether a scheduled entity such as a UE successfully received the data flow. In one aspect, the aforementioned means may be the processor(s) 1704 including the data flow scheduling circuitry 1740 and the relay identification circuitry 1742 shown in FIG. 17 configured to perform the functions recited by the aforementioned means. In another example, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 2, 3, and/or 4, and utilizing, for example, the example processes and/or techniques described herein with reference to FIGS. 7-16.

### Scheduled Entity

FIG. 18 is a block diagram conceptually illustrating an example of a hardware implementation for an exemplary scheduled entity 1800 employing a processing system 1814. In accordance with various aspects of the disclosure, the processing system 1814 may include an element, or any portion of an element, or any combination of elements having one or more processors 1804. For example, the scheduled entity 1800 may be a user equipment (UE) as illustrated in any one or more of FIGS. 1, 2, 3, 5-7, 10, 15, and/or 16.

The processing system 1814 may be substantially the same as the processing system 1714 illustrated in FIG. 17, including a bus interface 1808, a bus 1802, memory 1805, a processor 1804, and a computer-readable medium 1806. Furthermore, the scheduled entity 1800 may include a user interface 1812 and a transceiver 1810 substantially similar to those described with reference to FIG. 17. That is, the processor 1804, as utilized in a scheduled entity 1800, may be utilized (e.g., in coordination with the memory 1805 and the transceiver 1810) to implement any one or more of the processes described herein with reference, for example, to FIG. 9.

In some aspects of the disclosure, the processor 1804 may include channel state reporting circuitry 1840 configured (e.g., in coordination with the memory 1805 and/or transceiver 1810) for various functions, including, for example, communicating according to a suitable standard or protocol, as described herein. For example, the channel state reporting circuitry 1840 may be configured to implement one or more of the functions described herein, for example, with reference to FIG. 9, including, e.g., blocks 902-908 and/or block 912, etc. In an example, a downstream UE transmits one or more channel state reports to an upstream scheduling entity (e.g., an entity upstream from the downstream UE and the relay device). In such examples, the upstream scheduling entity obtains the channel state report from the downstream UE via the channel state reporting circuitry 1840. In some examples, the scheduling entity 1700 may utilize relay identification circuitry 1742 to obtain the one or more channel state reports from the UE, such that the scheduling entity 1700 may utilize the channel state report(s) to identify a relay device to leverage for relaying data to the downstream UE.

In some aspects of the disclosure, the processor 1004 may include data flow receiving circuitry 1842 configured (e.g., in coordination with the memory 1805 and the channel state reporting circuitry 1840) for various functions, including, for example, managing power consumption of portions of the data flow receiving circuitry 1842 and/or transceiver 1810. For example, the data flow receiving circuitry 1842 may be configured to implement one or more of the functions in cooperation with the acknowledgment circuitry 1844 as described herein, for example, those described with reference to FIG. 13, including, e.g., blocks 1310 and 1312.

In some aspects of the disclosure, the processor 1004 may include acknowledgment circuitry 1844 configured (e.g., in coordination with the memory 1805 and the data flow receiving circuitry 1842) for various functions, including, for example, managing power consumption of portions of the data flow receiving circuitry 1842 and/or transceiver 1810. For example, the acknowledgment circuitry 1844 may be configured to implement one or more of the functions in cooperation with the channel state reporting 1840 as described herein, for example, those described with reference to FIG. 8, including, e.g., block 804.

And further, the computer-readable storage medium 1806 may store computer-executable code that includes channel state reporting instructions 1850 that configure a scheduled entity 1800 for various functions, including, e.g., generating and transmitting a UE group report. For example, the channel state reporting instructions 1850 may be configured to cause a scheduled entity 1800 to implement one or more of the functions described herein, for example, with reference to FIG. 8, including, e.g., blocks 802-806. The channel state reporting instructions 1850 may further be configured to cause a scheduled entity 1800 to implement one or more of the functions described herein, for example, with reference to FIG. 9, including, e.g., blocks 902-908 and 914. In some aspects of the disclosure, the instructions 1806 may include data flow receiving instructions 1852 configured, e.g., in coordination with the memory 1805 and the channel state reporting instructions 1850. The data flow receiving instructions 1852 may configure a scheduled entity 1800 for various functions, including, e.g., monitoring for the data flow and discontinuing monitoring in certain instances for power savings. For example, the data flow receiving instructions 1852 may be configured to implement one or more of the functions in cooperation with the data flow receiving circuitry 1842 as described herein, for example, with reference to FIG. 11 including, e.g., block 1108, or FIG. 13 including, e.g., blocks 1308 and 1310.

In some aspects of the disclosure, the instructions 1806 may include acknowledgment instructions 1854 configured (e.g., in coordination with the memory 1805 and the data flow receiving instructions 1852). The acknowledgment instructions 1854 may configure a scheduled entity 1800 for various functions, including, e.g., transmitting hybrid automatic repeat request (HARQ) acknowledgment feedback. For example, the acknowledgment instructions 1854 may be configured to implement one or more of the functions in cooperation with the data flow receiving circuitry 1842 as described herein, for example, with reference to FIG. 14 including, e.g., blocks 1404 and 1408.

In some examples, the scheduled entity 1800 (e.g., an apparatus for wireless communication) includes means for generating and transmitting a UE group channel state report, means for receiving the data flow over the multiple radio links, and means for transmitting HARQ-ACK information indicating whether the scheduled entity 1800 successfully received the data flow. In one aspect, the aforementioned means may be the processor(s) 1804 including the channel state reporting circuitry 1840, the data flow receiving circuitry 1842, and the acknowledgment circuitry 1844 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1, 2, 3, and/or 4, and utilizing, for example, the example processes and/or techniques described herein, for example, with reference FIGS. 7-16.

### Further Examples Having a Variety of Features

The disclosure may be further understood by way of the following examples:

Example 1: A method, device, and system of wireless communication operable at a first device (e.g., a destination user equipment (UE)), including: receiving, from at least one upstream scheduling entity, a control message indicating the first device is to monitor at least one first radio link and at least one second radio link for at least one data flow from the at least one upstream scheduling entity over: the at least one first radio link between the first device and the at least one upstream scheduling entity, and the at least one second radio link between the first device and at least one second device; monitoring the at least one first radio link for a first portion of the at least one data flow; monitoring the at least one second radio link for a second portion of the at least one data flow; receiving at least one of: the first portion of the at least one data flow including DL data for the first device, or the second portion of the at least one data flow including relay data for the first device; and transmitting an indication (e.g., an acknowledgment message, etc.) corresponding to at least one of: the DL data or the relay data.

Example 2: A method, device, and system according to Example 1, wherein the receiving of the control message includes: receiving an indication that the at least one second device is configured to serve as a relay for communicating the second portion of the at least one data flow; or receiving a request from the upstream scheduling entity for channel state information (CSI) corresponding to the at least one second radio link.

Example 3: A method, device, and system according to Example 2, wherein the receiving of the indication includes: determining, via a medium access control (MAC) entity, an activation of the at least one second device as the relay; determining, via a physical downlink control channel (PDCCH), DL control information (DCI) identifying the at least one second device as the relay; and/or determining, via a physical sidelink control channel (PSCCH), sidelink (SL) control information (SCI) identifying the at least one second device as the relay, wherein the second portion of the at least one data flow is received, via a physical sidelink shared channel (PSSCH), in tandem with the first portion of the at least one data flow.

Example 4: A method, device, and system according to any one of Examples 2 and/or 3, further including: obtaining the channel state information (CSI) corresponding to the at least one second radio link; transmitting a CSI report to the at least one second device, the CSI report including the CSI corresponding to the at least one second radio link; and determining to monitor the at least one second radio link for the second portion of the at least one data flow.

Example 5: A method, device, and system according to any one of Examples 1 through 4, wherein the receiving of the second portion of the at least one data flow includes: identifying scheduling information for the first device to utilize to receive the relay data of the at least one data flow; and receiving the relay data according to the scheduling information.

Example 6: A method, device, and system according to Example 5, wherein the receiving of the control message includes: receiving a control channel from at least one of: the at least one second device or the at least one upstream scheduling entity, the control channel including the scheduling information for the first device to utilize to receive the relay data.

Example 7: A method, device, and system according to any one of Examples 1 through 6, wherein the receiving of the second portion of the at least one data flow includes: receiving, via a physical layer of the at least one second device, the relay data according to a predefined rule, the predefined rule indicating an allocation of communication resources relative to a physical layer of the first device for receiving the relay data over the second radio link.

Example 8: A method, device, and system according to any one of Examples 1 through 7, wherein the receiving of the first portion of the at least one data flow includes: utilizing a first transport block size to receive the DL data; and wherein the receiving of the second portion of the at least one data flow includes: utilizing a second transport block size to receive the relay data, the second transport block size differing from the first transport block size corresponding to the DL data of the first portion of the at least one data flow.

Example 9: A method, device, and system according to any one of Examples 1 through 8, wherein the transmitting of the acknowledgment message corresponding to the DL data includes: transmitting, over the at least one first radio link, the acknowledgment message corresponding to the DL data when the first device receives the DL data during a first timeframe of a first predetermined feedback timeline; and transmitting, over the at least one first radio link, a negative acknowledgment in instances where the first device fails to receive the DL data and the relay data during the first timeframe and during a second timeframe of a second predetermined feedback timeline.

Example 10: A method, device, and system according to Example 9, wherein the transmitting of the acknowledgment message corresponding to the relay data includes: transmitting, over the at least one first radio link, the acknowledgment message corresponding to the relay data when the first device receives the relay data during the first timeframe and fails to receive the DL data during the first timeframe; and transmitting, over the at least one first radio link, the acknowledgement message corresponding to the relay data when the first device receives the relay data during the second timeframe and fails to receive the DL data prior to receiving the relay data during the second timeframe.

Example 11: A method of wireless communication operable at a relay device, including: receiving, over a first radio link, a first portion of at least one data flow from an upstream scheduling entity (e.g., a base station (BS)), the first portion of the at least one data flow including relay data for at least one downstream device; determining an allocation of communication resources relative to a physical layer of the relay device to utilize for communicating the relay data to the at least one downstream device; and transmitting, via the physical layer of the relay device, the relay data to the at least one downstream device over a second radio link, the relay data being related to downlink (DL) data destined for the downstream device over a third radio link between the downstream device and the upstream scheduling entity.

Example 12: A method, device, and system according to Example 11, wherein the receiving of the first portion of the at least one data flow from the upstream scheduling entity includes: determining an indicator identifying the relay device as a relay for communicating the relay data to the at least one downstream device; or receiving a request from the upstream scheduling entity for channel state information (CSI) corresponding to the second radio link.

Example 13: A method, device, and system according to Example 12, wherein the transmitting of the relay data includes: transmitting, via a physical sidelink control channel (PSCCH), sidelink (SL) control information (SCI) to the at least one downstream device identifying the relay device as the relay.

Example 14: A method, device, and system according to Example 12, further including: obtaining the channel state information (CSI) corresponding to the first radio link and the second radio link; and transmitting, to the upstream scheduling entity, at least one CSI report over the first radio link, the at least one CSI report including the CSI corresponding to at least one of: the first radio link or the second radio link.

Example 15: A method, device, and system according to any one or more of Examples 11 through 14, wherein the transmitting of the relay data includes: identifying scheduling information for the relay device to utilize to transmit the relay data; and transmitting, to the downstream device, the relay data according to the scheduling information.

Example 16: A method, device, and system according to Example 15, wherein the identifying of the scheduling information includes: receiving, as the scheduling information, a data transmission setting defining a set of semi-persistent scheduling (SPS) parameters for the relay device to utilize to transmit the relay data.

Example 17: A method, device, and system according to Example 15, wherein the transmitting of the relay data includes: transmitting, to the downstream device, a data channel including the relay data; and receiving, from the downstream device, a negative acknowledgment indicating the downstream device failed to decode the data channel within a time corresponding to the scheduling information.

Example 18: A method, device, and system according to any one or more of Examples 1 through 17, wherein the transmitting of the relay data includes: transmitting the relay data according to a predefined rule, the predefined rule indicating a data resource allocation for transmitting the first portion of the at least one data flow.

Example 19: A method, device, and system according to any one or more of Examples 1 through 18, wherein the receiving of the first portion of the at least one data flow includes: utilizing a first transport block size to receive the relay data; and wherein the transmitting of the relay data includes: utilizing a second transport block size to transmit the relay data to the at least one downstream device.

Example 20: A method, device, and system according to Example 19, wherein the first transport block size and the second transport block size are different sizes.

Example 21: A method, device, and system of wireless communication operable at a first device, the method including: transmitting at least one control message to at least one second device indicating the at least one second device is to monitor for at least one data flow over: at least one first radio link, and at least one second radio link; transmitting, to the at least one second device via a physical layer of the first device, a first portion of the at least one data flow over the at least one first radio link, the first portion of the at least one data flow including downlink (DL) data for the at least one second device; transmitting, to at least one third device via the physical layer of the first device, a second portion of the at least one data flow over the at least one second radio link, the second portion of the at least one data flow including relay data for the at least one second device related to the DL data for the at least one second device, the at least one third device being interposed between the first device and the at least one second device; and receiving an acknowledgment message corresponding to at least one of: the DL data or the relay data.

Example 22: A method, device, and system according to Example 21, wherein the transmitting of the at least one control message includes: transmitting an indication that the at least one third device is configured to serve as a relay for communicating the second portion of the at least one data flow; or transmitting a request for channel state information (CSI) corresponding to the at least one second radio link.

Example 23: A method, device, and system according to Example 22, wherein the transmitting of the indication includes: indicating, via a medium access control (MAC) entity, an activation of the at least one third device as the relay; or transmitting, via a physical downlink control channel (PDCCH), DL control information (DCI) identifying the at least one third device as the relay.

Example 24: A method, device, and system according to any one of Examples 22 or 23, further including: receiving a CSI report from the at least one second device, the CSI report including the CSI corresponding to the at least one second radio link; and determining to transmit the second portion of the at least one data flow over the at least one second radio link.

Example 25: A method, device, and system according to any one or more of Examples 21 through 24, further including: transmitting, to the at least one second device, a control channel including scheduling information for the at least one second device to utilize to receive the DL data.

Example 26: A method, device, and system according to Example 25, wherein the scheduling information further includes scheduling information for the at least one second device to utilize to receive the relay data from the at least one third device.

Example 27: A method, device, and system according to any one of Examples 25 or 26, wherein the transmitting of the second portion of the at least one data flow includes: transmitting, via the second portion of the at least one data flow, a data transmission setting for the at least one third device to utilize to transmit the relay data to the at least one second device, and wherein the transmitting of the first portion of the at least one data flow includes: transmitting, via the first portion of the at least one data flow, the data transmission setting for the at least one second device to receive the relay data from the at least one third device.

Example 28: A method, device, and system according to any one or more of Examples 21 through 27, wherein the receiving of the acknowledgment message includes: receiving, over the at least one first radio link, the acknowledgment message during a first timeframe of a first predetermined feedback timeline; or receiving, over the at least one first radio link, a negative acknowledgment during a second timeframe of a second predetermined feedback timeline, the negative acknowledgment indicative of the at least one second device failing to receive the DL data and the relay data during the first timeframe and during the second timeframe.

Example 29: A method, device, and system according to Example 28, wherein the receiving of the acknowledgment message includes: receiving, over the at least one second radio link, the acknowledgment message during the first timeframe indicative of the at least one second device receiving the relay data during the first timeframe and failing to receive the DL data during the first timeframe; and receiving, over the at least one first radio link, the acknowledgment message during the second timeframe indicative of the at least one second device receiving at least one of: the DL data or the relay data.

Example 30: A method, device, and system according to any one or more of Examples 21 through 29, wherein the transmitting of the first portion of the data flow and the transmitting of the second portion of the data flow includes: transmitting the first portion of the at least one data flow contemporaneously with the second portion of the at least one data flow to provide the at least one second device with the at least one data flow via at least one of: the DL data or the relay data.

Example 31: A method, device, and system of wireless communication operable at a first device (e.g., a destination UE, etc.), including: receiving, from at least one scheduling entity, an indication configured to indicate that the first device is to monitor at least one first radio link and at least one second radio link for at least one data flow from the at least one scheduling entity; receiving at least one of: a first portion of at least one data flow via at least one first radio link, the first portion including downlink (DL) data for the first device, or a second portion of the at least one data flow via at least one second radio link, the second portion including relay data for the first device; and transmitting an indication corresponding to at least one of: the DL data, or the relay data.

Example 32: A method, device, and system according to Example 31, wherein the at least one first radio link includes a communication path between the first device and the at least one scheduling entity, and the at least one second radio link includes a communication path between the first device and the at least one second device.

Example 33: A method, device, and system according to any one of Examples 31 or 32, wherein the receiving of the indication includes: receiving a control message indicating the at least one second device includes a relay for communicating the second portion of the at least one data flow to the first device; or receiving a request, from the scheduling entity, for channel state information (CSI) corresponding to the at least one second radio link.

Example 34: A method, device, and system according to Example 33, wherein the receiving of the indication includes: determining, via a medium access control (MAC) entity, an activation of the at least one second device as the relay; determining, via a physical downlink control channel (PDCCH), DL control information (DCI) identifying the at least one second device as the relay; or determining, via a physical sidelink control channel (PSCCH), sidelink (SL) control information (SCI) identifying the at least one second device as the relay, wherein the second portion of the at least one data flow is received, via a physical sidelink shared channel (PSSCH), in tandem with the first portion of the at least one data flow.

Example 35: A method, device, and system according to any one of Examples 33 or 34, further including: obtaining the channel state information (CSI) corresponding to the at least one second radio link; transmitting a CSI report to the at least one second device, the CSI report including the CSI corresponding to the at least one second radio link; and determining to monitor the at least one second radio link for the second portion of the at least one data flow.

Example 36: A method, device, and system according to any one or more of Examples 31 through 35, wherein the receiving of the second portion of the at least one data flow includes: identifying scheduling information for the first device to utilize to receive the relay data of the at least one data flow; and receiving the relay data according to the scheduling information.

Example 37: A method, device, and system according to Example 36, wherein the receiving of the indication includes: receiving a control channel from at least one of: the at least one second device or the at least one scheduling entity, the control channel including the scheduling information for the first device to utilize to receive the relay data.

Example 38: A method, device, and system according to any one or more of Examples 31 through 37, wherein the receiving of the second portion of the at least one data flow includes: receiving, via a physical layer associated with the at least one second device, the relay data according to a predefined rule, the predefined rule indicating an allocation of communication resources relative to a physical layer associated with the first device.

Example 39: A method, device, and system according to any one or more of Examples 31 through 38, wherein the receiving of the first portion of the at least one data flow includes: utilizing a first transport block size to receive the DL data; and wherein the receiving of the second portion of the at least one data flow includes: utilizing a second transport block size to receive the relay data, the second transport block size differing from the first transport block size corresponding to the DL data of the first portion of the at least one data flow.

Example 40: A method, device, and system according to any one or more of Examples 31 through 39, wherein the transmitting of the indication corresponding to the DL data includes: transmitting, over the at least one first radio link, an acknowledgment message corresponding to the DL data when the first device receives the DL data during a first timeframe of a first predetermined feedback timeline; and transmitting, over the at least one first radio link, a negative acknowledgment in instances where the first device fails to receive the DL data and the relay data during the first timeframe and during a second timeframe of a second predetermined feedback timeline.

Example 41: A method, device, and system of wireless communication operable at a relay device (e.g., a relay user equipment (UE)), the method including: receiving, over a first radio link, a first portion of at least one data flow from a scheduling entity, the first portion of the at least one data flow including relay data; determining an allocation of communication resources relative to a physical layer associated with the relay device, the relay device configured to utilize the physical layer for communicating the relay data to at least one destination device; and transmitting, via the allocation of communication resources of the physical layer, the relay data to the at least one destination device over a second radio link, the relay data associated with downlink (DL) data destined for the at least one destination device over a third radio link between the at least one device and the scheduling entity.

Example 42: A method, device, and system according to Example 41, wherein the receiving of the first portion of the at least one data flow from the scheduling entity includes: determining an indicator identifying the relay device as a relay for communicating the relay data to the at least one destination device; or receiving a request from the scheduling entity for channel state information (CSI) corresponding to the second radio link.

Example 43: A method, device, and system according to any one of Examples 41 or 42, wherein the transmitting of the relay data includes: transmitting, via a physical sidelink control channel (PSCCH), sidelink (SL) control information (SCI) to the at least one destination device identifying the relay device as the relay.

Example 44: A method, device, and system according to any one of Examples 42 or 43, further including: obtaining the channel state information (CSI) corresponding to the first radio link and the second radio link; and transmitting, to the scheduling entity, at least one CSI report over the first radio link, the at least one CSI report including the CSI corresponding to at least one of: the first radio link or the second radio link.

Example 45: A method, device, and system according to any one or more of Examples 41 through 44, wherein the transmitting of the relay data includes: identifying scheduling information for the relay device to utilize to transmit the relay data; and transmitting, to the at least one destination device, the relay data according to the scheduling information.

Example 46: A method, device, and system according to Example 45, wherein the identifying of the scheduling information includes: receiving, as the scheduling information, a data transmission setting defining a set of semi-persistent scheduling (SPS) parameters for the relay device to utilize to transmit the relay data.

Example 47: A method, device, and system according to any one or more of Examples 41 through 46, wherein the transmitting of the relay data includes: transmitting the relay data according to a predefined rule, the predefined rule indicating a data resource allocation for transmitting the first portion of the at least one data flow.

Example 48: A method, device, and system according to any one or more of Examples 41 through 47, wherein the receiving of the first portion of the at least one data flow includes: utilizing a first transport block size to receive the relay data; and wherein the transmitting of the relay data includes: utilizing a second transport block size to transmit the relay data to the at least one device.

Example 49: A method, device, and system according to Example 48, wherein the first transport block size and the second transport block size are different sizes.

Example 50: A method, device, and system of wireless communication operable at a first device, the method including: transmitting at least one indication to at least one second device, the at least one indication configured to indicate that the at least one second device is to monitor for at least one data flow over: at least one first radio link, and at least one second radio link; transmitting, to the at least one second device via a physical layer associated with the first device, a first portion of the at least one data flow over the at least one first radio link, the first portion of the at least one data flow including downlink (DL) data for the at least one second device; transmitting, to at least one third device via the physical layer associated with the first device, a second portion of the at least one data flow over the at least one second radio link, the second portion of the at least one data flow including relay data for the at least one second device; and receiving an indication corresponding to at least one of: the DL data or the relay data.

Example 51: A method, device, and system according to Example 50, wherein the transmitting of the at least one indication includes: transmitting a control message indicating the at least one third device includes a relay for communicating the second portion of the at least one data flow to the first device; or transmitting a request for channel state information (CSI) corresponding to the at least one second radio link.

Example 52: A method, device, and system according to Example 51, wherein the transmitting of the indication includes: indicating, via a medium access control (MAC) entity, an activation of the at least one third device as the relay; or transmitting, via a physical downlink control channel (PDCCH), DL control information (DCI) identifying the at least one third device as the relay.

Example 53: A method, device, and system according to any one of Examples 51 or 52, further including: receiving a CSI report from the at least one second device, the CSI report including the CSI corresponding to the at least one second radio link; and determining to transmit the second portion of the at least one data flow over the at least one second radio link.

Example 54: A method, device, and system according to any one or more of Examples 50 through 53, further including: transmitting, to the at least one second device, a control channel including scheduling information for the at least one second device to utilize to receive the DL data.

Example 55: A method, device, and system according to Example 54, wherein the scheduling information further includes scheduling information for the at least one second device to utilize to receive the relay data from the at least one third device.

Example 56: A method, device, and system according to any one of Examples 54 or 55, wherein the transmitting of the second portion of the at least one data flow includes: transmitting, via the second portion of the at least one data flow, a data transmission setting for the at least one third device to utilize to transmit the relay data to the at least one second device, and wherein the transmitting of the first portion of the at least one data flow includes: transmitting, via the first portion of the at least one data flow, the data transmission setting for the at least one second device to receive the relay data from the at least one third device.

Example 57: A method, device, and system according to any one or more of Examples 50 through 56, wherein the receiving of the indication includes: receiving, over the at least one first radio link, an acknowledgment message during a first timeframe of a first predetermined feedback timeline; or receiving, over the at least one first radio link, a negative acknowledgment during a second timeframe of a second predetermined feedback timeline, the negative acknowledgment indicative of the at least one second device failing to receive the DL data and the relay data during the first timeframe and during the second timeframe.

Example 58: A method, device, and system according to any one or more of Examples 50 through 57, wherein the transmitting of the first portion of the data flow and the transmitting of the second portion of the data flow includes: transmitting the first portion of the at least one data flow contemporaneously with the second portion of the at least one data flow to provide the at least one second device with the at least one data flow via at least one of: the DL data or the relay data.

Example 59: A wireless communication device, and system, including: processing circuitry, a transceiver communicatively coupled to the processing circuitry, and a memory communicatively coupled to the processor. The wireless communication device can, via the processing circuitry, be configured to: receive, via the transceiver, an indication configured to indicate that the wireless communication device is to monitor at least one first radio link and at least one second radio link for at least one data flow from the at least one scheduling entity; receive at least one of: a first portion of at least one data flow over at least one first radio link, the first portion including downlink (DL) data for the wireless communication device, or a second portion of the at least one data flow over at least one second radio link, the second portion including relay data for the wireless communication device; and transmit, via the transceiver, an indication corresponding to at least one of: the DL data, or the relay data.

Example 60: A wireless communication device, and system, according to Example 59, wherein the at least one first radio link includes a communication path between the wireless communication device and the at least one scheduling entity, and the at least one second radio link includes a communication path between the wireless communication device and the at least one second device.

Example 61: A wireless communication device, and system, according to any one of Examples 59 or 60, wherein to receive the indication, the processing circuitry (e.g., one or more processors, the processor and the memory, a processor with buffer memory or other memory, one or more processor(s) with buffer memory, etc.) is configured to: receive a control message indicating the at least one second device includes a relay for communicating the second portion of the at least one data flow; or receive a request, from the scheduling entity, for channel state information (CSI) corresponding to the at least one second radio link.

Example 62: A wireless communication device, and system, according to Example 61, wherein to receive the indication, the processing circuitry (e.g., one or more processors, the processor and the memory, a processor with buffer memory or other memory, one or more processor(s) with buffer memory, etc.) is configured to: determine, via a medium access control (MAC) entity, an activation of the at least one second device as the relay; determine, via a physical downlink control channel (PDCCH), DL control information (DCI) identifying the at least one second device as the relay; or determine, via a physical sidelink control channel (PSCCH), sidelink (SL) control information (SCI) identifying the at least one second device as the relay.

Example 63: A wireless communication device, and system, according to any one of Examples 61 or 62, wherein the processing circuitry (e.g., one or more processors, the processor and the memory, a processor with buffer memory or other memory, one or more processor(s) with buffer memory, etc.) is further configured to: obtain the channel state information (CSI) corresponding to the at least one second radio link; transmit a CSI report to the at least one second device, the CSI report including the CSI corresponding to the at least one second radio link; and determine to monitor the at least one second radio link for the second portion of the at least one data flow.

Example 64: A wireless communication device, and system, according to any one or more of Examples 59 through 63, wherein to receive the second portion of the at least one data flow, the processing circuitry (e.g., one or more processors, the processor and the memory, a processor with buffer memory or other memory, one or more processor(s) with buffer memory, etc.) is configured to: identify scheduling information to utilize when receiving the relay data; and receive the relay data according to the scheduling information.

Example 65: A wireless communication device, and system, according to Example 64, wherein to receive the indication, the processing circuitry (e.g., one or more processors, the processor and the memory, a processor with buffer memory or other memory, one or more processor(s) with buffer memory, etc.) is configured to: receive a control channel from at least one of: the at least one second device or the at least one scheduling entity, the control channel including the scheduling information.

Example 66: A wireless communication device, and system, according to any one or more of Examples 59 through 65, wherein to receive the second portion of the at least one data flow, the processing circuitry (e.g., one or more processors, the processor and the memory, a processor with buffer memory or other memory, one or more processor(s) with buffer memory, etc.) is configured to: receive, over the at least one second radio link, the relay data according to a predefined rule, the predefined rule indicating an allocation of communication resources relative to a physical layer associated with the wireless communication device.

Example 67: A wireless communication device, and system, according to any one or more of Examples 59 through 66, wherein to receive the first portion of the at least one data flow, the processing circuitry (e.g., one or more processors, the processor and the memory, a processor with buffer memory or other memory, one or more processor(s) with buffer memory, etc.) is configured to: utilize a first transport block size to receive the DL data; and wherein to receive the second portion of the at least one data flow, the processing circuitry (e.g., one or more processors, the processor and the memory, a processor with buffer memory or other memory, one or more processor(s) with buffer memory, etc.) is configured to: utilize a second transport block size to receive the relay data.

Example 68: A wireless communication device, and system, according to Example 67, wherein the first transport block size and the second transport block size are different sizes.

Example 69: A wireless communication device, and system, according to any one or more of Examples 59 through 68, wherein to transmit the indication corresponding to the DL data, the processing circuitry (e.g., one or more processors, the processor and the memory, a processor with buffer memory or other memory, one or more processor(s) with buffer memory, etc.) is configured to: transmit, over the at least one first radio link, an acknowledgment message corresponding to the DL data when the wireless communication device receives the DL data during a first timeframe of a first predetermined feedback timeline; and transmit, over the at least one first radio link, a negative acknowledgment in instances where the wireless communication device fails to receive the DL data and the relay data during the first timeframe and during a second timeframe of a second predetermined feedback timeline.

Example 70: A wireless communication device, and system, including: processing circuitry, a transceiver communicatively coupled to the processing circuitry, and a memory communicatively coupled to the processor. The wireless communication device can, via the processing circuitry, be configured to: receive, over a first radio link, a first portion of at least one data flow from a scheduling entity, the first portion of the at least one data flow including relay data; and transmit, via a physical layer associated with the wireless communication device, the relay data to at least one device over a second radio link, the relay data associated with downlink (DL) data destined for the at least one device over a third radio link between the at least one device and the scheduling entity.

Example 71: A wireless communication device, and system, according to Example 70, wherein to receive the first portion of the at least one data flow from the scheduling entity, the processing circuitry (e.g., one or more processors, the processor and the memory, a processor with buffer memory or other memory, one or more processor(s) with buffer memory, etc.) is configured to: determine an indicator identifying the wireless communication device as a relay for communicating the relay data to the at least one device; or receive a request from the scheduling entity for channel state information (CSI) corresponding to the second radio link.

Example 72: A wireless communication device, and system, according to any one of Examples 70 or 71, wherein to transmit the relay data, the processing circuitry (e.g., one or more processors, the processor and the memory, a processor with buffer memory or other memory, one or more processor(s) with buffer memory, etc.) is configured to: transmit, via a physical sidelink control channel (PSCCH), sidelink (SL) control information (SCI) to the at least one device identifying the wireless communication device as the relay.

Example 73: A wireless communication device, and system, according to any one of Examples 71 or 72, wherein the processing circuitry (e.g., one or more processors, the processor and the memory, a processor with buffer memory or other memory, one or more processor(s) with buffer memory, etc.) is further configured to: obtain the channel state information (CSI) corresponding to the first radio link and the second radio link; and transmit, to the scheduling entity, at least one CSI report over the first radio link, the at least one CSI report including the CSI corresponding to at least one of: the first radio link or the second radio link.

Example 74: A wireless communication device, and system, according to any one or more of Examples 70 through 73, wherein to transmit of the relay data, the processing circuitry (e.g., one or more processors, the processor and the memory, a processor with buffer memory or other memory, one or more processor(s) with buffer memory, etc.) is configured to: identify scheduling information for the wireless communication device to utilize to transmit the relay data; and transmit, to the device, the relay data according to the scheduling information.

Example 75: A wireless communication device, and system, according to Example 74, wherein to identify the scheduling information, the processing circuitry (e.g., one or more processors, the processor and the memory, a processor with buffer memory or other memory, one or more processor(s) with buffer memory, etc.) is configured to: receive, as the scheduling information, a data transmission setting defining a set of semi-persistent scheduling (SPS) parameters for the wireless communication device to utilize to transmit the relay data.

Example 76: A wireless communication device, and system, according to any one or more of Examples 70 through 75, wherein to transmit the relay data, the processing circuitry (e.g., one or more processors, the processor and the memory, a processor with buffer memory or other memory, one or more processor(s) with buffer memory, etc.) is configured to: transmit the relay data according to a predefined rule, the predefined rule indicating a data resource allocation for transmitting the first portion of the at least one data flow.

Example 77: A wireless communication device, and system, according to any one or more of Examples 70 through 76, wherein to receive the first portion of the at least one data flow, the processing circuitry (e.g., one or more processors, the processor and the memory, a processor with buffer memory or other memory, one or more processor(s) with buffer memory, etc.) is configured to: utilize a first transport block size to receive the relay data; and wherein to transmit the relay data, the processing circuitry (e.g., one or more processors, the processor and the memory, a processor with buffer memory or other memory, one or more processor(s) with buffer memory, etc.) is configured to: utilize a second transport block size to transmit the relay data to the at least one device.

This disclosure presents several aspects of a wireless communication network with reference to an exemplary implementation. The actual telecommunication standard, network architecture, and/or communication standard employed will depend on the specific application and the overall design constraints imposed on the system. NR is an emerging wireless communications technology under development. As those skilled in the art will readily appreciate, various aspects described throughout this disclosure may be extended to other telecommunication systems, network architectures and communication standards.

By way of example, the various aspects of this disclosure may be implemented within systems defined by, and/or described in documents from, an organization named “3rd Generation Partnership Project” (3GPP), such as Long-Term Evolution (LTE), as well as others including the Evolved Packet System (EPS), and/or the Universal Mobile Telecommunication System (UMTS), and/or the Global System for Mobile (GSM). Various aspects may also be extended to systems defined by, and/or described in documents from, an organization named the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. It should be noted that the terms “network” and “system” are often used interchangeably.

In some examples, a CDMA network may implement a radio technology such as Universal Terrestrial Radio Access (UTRA), which includes Wideband CDMA (WCDMA) as well as other variants. A TDMA network may implement a radio technology such as Global System for Mobile Communications (GSM). An OFDMA network may implement a radio technology such as NR (e.g., 5G NR), Evolved UTRA (E-UTRA), Ultra Mobile Broadband (UMB), IEEE 802.11 (WiFi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use EUTRA. UTRA, E-UTRA, UMTS, LTE, LTE-A, UMB, and GSM are described in 3GPP documents.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

The present disclosure uses the term “coupled” and/or “communicatively coupled” to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-18 may be configured to perform one or more of the methods, features, or steps described herein. The novel algorithms described herein may also be efficiently implemented in software and/or embedded in hardware.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of”' a list of items refers to any combination of those items, including single members. As an example, “at least one of: a, b, or c” is intended to cover: a; b; c; a and b (a-b); a and c (a-c); b and c (b-c); and a, b and c (a-b-c), as well as any combination with multiples of the same element (e.g., a-a, a-a-a, a-a-b, a-a-c, a-b-b, acc, b-b, b-b-b, b-b-c, c-c, and c-c-c or any other ordering of a, b, and c). As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information, such as a reference signal), accessing (e.g., accessing data in a memory) and the like. Also, “determining” may include resolving, selecting, choosing, establishing and the like.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The various operations of the disclosed technology may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

It is to be understood that the claims are not limited to the precise configuration and components illustrated above. Various modifications, changes and variations may be made in the arrangement, operation and details of the methods and apparatus described herein without departing from the scope of the claims. The description of the disclosed technology is provided to enable those skilled in the art to practice the various aspects described herein. The claims, however, are not intended to be limited to the aspects shown herein, but are to be accorded the full scope consistent with the language of the claims. Various modifications to these aspects will be readily apparent to those skilled in the art, and the generic principles defined herein may be applied to other aspects.

1. A method of wireless communication operable at a first device, the method comprising:
receiving, from at least one scheduling entity, an indication configured to indicate that the first device is to monitor at least one first radio link and at least one second radio link for at least one data flow from the at least one scheduling entity;
receiving at least one of:
a first portion of at least one data flow via at least one first radio link, the first portion comprising downlink (DL) data for the first device, or
a second portion of the at least one data flow via at least one second radio link, the second portion comprising relay data for the first device; and
transmitting an indication corresponding to at least one of: the DL data, or the relay data.

2. The method of claim 1, wherein the at least one first radio link comprises a communication path between the first device and the at least one scheduling entity, and the at least one second radio link comprises a communication path between the first device and the at least one second device.

3. The method of claim 1, wherein the receiving of the indication comprises:
receiving a control message indicating the at least one second device comprises a relay for communicating the second portion of the at least one data flow to the first device; or
receiving a request, from the scheduling entity, for channel state information (CSI) corresponding to the at least one second radio link.

4. The method of claim 3, wherein the receiving of the indication comprises:
determining, via a medium access control (MAC) entity, an activation of the at least one second device as the relay;
determining, via a physical downlink control channel (PDCCH), DL control information (DCI) identifying the at least one second device as the relay; or
determining, via a physical sidelink control channel (PSCCH), sidelink (SL) control information (SCI) identifying the at least one second device as the relay, wherein the second portion of the at least one data flow is received, via a physical sidelink shared channel (PSSCH), in tandem with the first portion of the at least one data flow.

5. The method of claim 3, further comprising:
obtaining the channel state information (CSI) corresponding to the at least one second radio link;
transmitting a CSI report to the at least one second device, the CSI report including the CSI corresponding to the at least one second radio link; and
determining to monitor the at least one second radio link for the second portion of the at least one data flow.

6. The method of claim 1, wherein the receiving of the second portion of the at least one data flow comprises:
identifying scheduling information for the first device to utilize to receive the relay data of the at least one data flow; and
receiving the relay data according to the scheduling information.

7. The method of claim 6, wherein the receiving of the indication comprises:
receiving a control channel from at least one of: the at least one second device or the at least one scheduling entity, the control channel comprising the scheduling information for the first device to utilize to receive the relay data.

8. The method of claim 1, wherein the receiving of the second portion of the at least one data flow comprises:
receiving, via a physical layer associated with the at least one second device, the relay data according to a predefined rule, the predefined rule indicating an allocation of communication resources relative to a physical layer associated with the first device.

9. The method of claim 1,
wherein the receiving of the first portion of the at least one data flow comprises:
utilizing a first transport block size to receive the DL data; and
wherein the receiving of the second portion of the at least one data flow comprises:
utilizing a second transport block size to receive the relay data, the second transport block size differing from the first transport block size corresponding to the DL data of the first portion of the at least one data flow.

10. The method of claim 1, wherein the transmitting of the indication corresponding to the DL data comprises:
transmitting, over the at least one first radio link, an acknowledgment message corresponding to the DL data when the first device receives the DL data during a first timeframe of a first predetermined feedback timeline; and
transmitting, over the at least one first radio link, a negative acknowledgment in instances where the first device fails to receive the DL data and the relay data during the first timeframe and during a second timeframe of a second predetermined feedback timeline.

11. A method of wireless communication operable at a relay device, the method comprising:
receiving, over a first radio link, a first portion of at least one data flow from a scheduling entity, the first portion of the at least one data flow comprising relay data;
determining an allocation of communication resources relative to a physical layer associated with the relay device, the relay device configured to utilize the physical layer for communicating the relay data to at least one destination device; and
transmitting, via the allocation of communication resources of the physical layer, the relay data to the at least one destination device over a second radio link, the relay data associated with downlink (DL) data destined for the at least one destination device over a third radio link between the at least one device and the scheduling entity.

12. The method of claim 11, wherein the receiving of the first portion of the at least one data flow from the scheduling entity comprises:
determining an indicator identifying the relay device as a relay for communicating the relay data to the at least one destination device; or
receiving a request from the scheduling entity for channel state information (CSI) corresponding to the second radio link.

13. The method of claim 12, wherein the transmitting of the relay data comprises:
transmitting, via a physical sidelink control channel (PSCCH), sidelink (SL) control information (SCI) to the at least one destination device identifying the relay device as the relay.

14. The method of claim 12, further comprising:
obtaining the channel state information (CSI) corresponding to the first radio link and the second radio link; and
transmitting, to the scheduling entity, at least one CSI report over the first radio link, the at least one CSI report including the CSI corresponding to at least one of: the first radio link or the second radio link.

15. The method of claim 11, wherein the transmitting of the relay data comprises:
identifying scheduling information for the relay device to utilize to transmit the relay data; and
transmitting, to the at least one destination device, the relay data according to the scheduling information.

16. The method of claim 15, wherein the identifying of the scheduling information comprises:
receiving, as the scheduling information, a data transmission setting defining a set of semi-persistent scheduling (SPS) parameters for the relay device to utilize to transmit the relay data.

17. The method of claim 11, wherein the transmitting of the relay data comprises:
transmitting the relay data according to a predefined rule, the predefined rule indicating a data resource allocation for transmitting the first portion of the at least one data flow.

18. The method of claim 11,
wherein the receiving of the first portion of the at least one data flow comprises:
utilizing a first transport block size to receive the relay data; and
wherein the transmitting of the relay data comprises:
utilizing a second transport block size to transmit the relay data to the at least one device.

19. The method of claim 18, wherein the first transport block size and the second transport block size are different sizes.

20. A method of wireless communication operable at a first device, the method comprising:
transmitting at least one indication to at least one second device, the at least one indication configured to indicate that the at least one second device is to monitor for at least one data flow over: at least one first radio link, and at least one second radio link;
transmitting, to the at least one second device via a physical layer associated with the first device, a first portion of the at least one data flow over the at least one first radio link, the first portion of the at least one data flow comprising downlink (DL) data for the at least one second device;
transmitting, to at least one third device via the physical layer associated with the first device, a second portion of the at least one data flow over the at least one second radio link, the second portion of the at least one data flow comprising relay data for the at least one second device; and
receiving an indication corresponding to at least one of: the DL data or the relay data.

21. The method of claim 20, wherein the transmitting of the at least one indication comprises:
transmitting a control message indicating the at least one third device comprises a relay for communicating the second portion of the at least one data flow to the first device; or
transmitting a request for channel state information (CSI) corresponding to the at least one second radio link.

22. The method of claim 21, wherein the transmitting of the indication comprises:
indicating, via a medium access control (MAC) entity, an activation of the at least one third device as the relay; or
transmitting, via a physical downlink control channel (PDCCH), DL control information (DCI) identifying the at least one third device as the relay.

23. The method of claim 21, further comprising:
receiving a CSI report from the at least one second device, the CSI report including the CSI corresponding to the at least one second radio link; and
determining to transmit the second portion of the at least one data flow over the at least one second radio link.

24. The method of claim 20, further comprising:
transmitting, to the at least one second device, a control channel comprising scheduling information for the at least one second device to utilize to receive the DL data.

25. The method of claim 24, wherein the scheduling information further comprises scheduling information for the at least one second device to utilize to receive the relay data from the at least one third device.

26. The method of claim 24,
wherein the transmitting of the second portion of the at least one data flow comprises:
transmitting, via the second portion of the at least one data flow, a data transmission setting for the at least one third device to utilize to transmit the relay data to the at least one second device, and
wherein the transmitting of the first portion of the at least one data flow comprises:
transmitting, via the first portion of the at least one data flow, the data transmission setting for the at least one second device to receive the relay data from the at least one third device.

27. The method of claim 20, wherein the receiving of the indication comprises:
receiving, over the at least one first radio link, an acknowledgment message during a first timeframe of a first predetermined feedback timeline; or
receiving, over the at least one first radio link, a negative acknowledgment during a second timeframe of a second predetermined feedback timeline, the negative acknowledgment indicative of the at least one second device failing to receive the DL data and the relay data during the first timeframe and during the second timeframe.

28. The method of claim 20, wherein the transmitting of the first portion of the data flow and the transmitting of the second portion of the data flow comprises:
transmitting the first portion of the at least one data flow contemporaneously with the second portion of the at least one data flow to provide the at least one second device with the at least one data flow via at least one of: the DL data or the relay data.

29-47. (canceled)
